(19) United States
(12) Patent Application Publication
(10) Pub. No.: US 2017/0055255 A1
(43) Pub. Date: Feb. 23, 2017

(54) TECHNIQUES FOR RESPONSE FRAMES IN COOPERATIVE RECEPTION

(71) Applicant: QUALCOMM Incorporated, San Diego, CA (US)

(72) Inventors: Yan ZHOU, San Diego, CA (US); Simone MERLIN, San Diego, CA (US); Gwendolyn Denise BARRIAC, Encinitas, CA (US); Santosh Paul ABRAHAM, San Diego, CA (US); George CHERIAN, San Diego, CA (US)

(21) Appl. No.: 14/829,444

(22) Filed: Aug. 18, 2015

(51) Int. Cl. H04W 72/04; H04L 5/00

(52) U.S. Cl. CPC H04W 72/0446; H04W 72/0413; H04L 5/0055

(57) ABSTRACT

Various aspects are provided for cooperative reception. In one approach, a first access point (AP) may receive uplink data from a second AP, wherein the first AP and the second AP have an overlapping coverage area, where the uplink data is received at the first AP via the second AP from a wireless station within the overlapping coverage area. The first AP may communicate to the wireless station a block response frame associated with the uplink data. The block response frame may be a block acknowledgment frame. The block response frame may be communicated in response to a request by the wireless station or based on a scheduled time. The first AP may contend for a communications channel to communicate the block response frame. The wireless station or the first AP may set up the cooperative reception in which the second AP forwards the uplink data to the first AP.

### BACKGROUND

The present disclosure relates generally to telecommunications, and specifically to techniques for response frames in cooperative reception.

The deployment of wireless local area networks (WLANs) in the home, the office, and various public facilities is commonplace today. Such networks typically employ a wireless access point (AP) that connects a number of wireless stations (STAs) in a specific locality (e.g., home, office, public facility, etc.) to another network, such as the Internet or the like. A set of STAs can communicate with each other through a common AP in what is referred to as a basic service set (BSS). Nearby BSSs may have overlapping coverage areas and such BSSs may be referred to as overlapping BSSs or OBSSs.

In some WLAN network deployments, wireless stations may be at a cell's edge (e.g., the edge of coverage of an AP) and may have poor uplink transmission quality because of large path loss, fading, or interference. In one scenario, reception at different APs of data transmitted by a wireless station (e.g., uplink transmission) may be affected by time-varying interference from wireless stations in nearby BSSs (e.g., OBSSs). Because of the time-varying nature of the interference, it is possible that the data received at one of the APs is corrupted by interference from a wireless station in a respective OBSS, while the data received at another one of the APs is not corrupted by interference from a wireless station in a respective OBSS. The AP with the corrupted data may not properly respond (e.g., acknowledge reception) to the wireless station that transmitted the data because the corrupted data could not be decoded. Therefore, it is desirable to employ mechanisms or approaches that more effectively handle responding to uplink transmissions when the quality of those transmissions is poor.

### SUMMARY

In one aspect, a method for cooperative reception includes receiving, at a first access point, uplink data from a second access point, where the first access point and the second access point have an overlapping coverage area, and where the uplink data is received at the first access point via the second access point from a wireless station within the overlapping coverage area. The method may further include communicating to the wireless station, by the first access point, a block response frame associated with the uplink data.

In another aspect, an apparatus for cooperative reception includes means for receiving, at a first access point, uplink data from a second access point, where the first access point and the second access point have an overlapping coverage area, and where the uplink data is received at the first access point via the second access point from a wireless station within the overlapping coverage area. The apparatus may further include means for communicating to the wireless station, by the first access point, a block response frame associated with the uplink data.

In another aspect, an apparatus for cooperative reception includes a processor and a memory coupled with the processor via at least one bus, the memory storing instructions, that when executed by the processor, cause the processor to receive, at a first access point, uplink data from a second access point, where the first access point and the second access point have an overlapping coverage area, and where the uplink data is received at the first access point via the second access point, and to communicate to the wireless station a block response frame associated with the uplink data.

In yet another aspect, a method for cooperative reception includes receiving, at a first access point, demodulated payload bits and decoded information from one or more second access points, where the first access point and the one or more second access points have an overlapping coverage area, and where the demodulated payload bits and the decoded information are forwarded to the first access point by the one or more second access points after being obtained by the one or more second access points from uplink data transmitted by a wireless station within the overlapping coverage area. The method may also include identifying at least a demodulated bit sequence from the demodulated payload bits from the one or more second access points. The method may also include decoding the at least a demodulated bit sequence to produce a decoded bit sequence. The decoding may be based on combining the at least a demodulated bit sequence. The method may further include communicating to the wireless station a block response frame associated with the decoded bit sequence.

In another aspect, a method for cooperative reception includes transmitting, by a wireless station, uplink data to a primary access point and a secondary access point, the wireless station transmitting the uplink data from within an overlapping coverage area of the primary access point and the secondary access point. The method may also include receiving, at the wireless station, an indication from the secondary access point that the uplink data has been forwarded by the secondary access point to the primary access point. The method may further include transmitting, by the wireless station, a request to the primary access point for a block response frame associated with the uplink data in response to receiving the indication from the secondary access point.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of a wireless local area network (WLAN) deployment;

FIG. 2A is a conceptual diagram illustrating an example of an inter-BSS cooperative reception scenario;

FIG. 2B is a conceptual diagram illustrating an example of an inter-AP communications link for cooperative reception;

FIG. 3A is a conceptual timing diagram illustrating an example of a block response frame transmission by a Primary AP in response to a wireless station request;

FIG. 3B is a conceptual timing diagram illustrating an example of a wireless station request after an indication that decoded data has been forwarded to a Primary AP;

FIG. 4A is a conceptual timing diagram illustrating an example of a block response frame transmission by a Primary AP at a scheduled time;

FIG. 4B is a conceptual timing diagram illustrating an example of a block response frame transmission by a Primary AP during a scheduled time window;

FIG. 5 is a conceptual timing diagram illustrating an example of a response frame transmission at a same time by each of a Primary AP and a Secondary AP;

FIG. 6 is a conceptual timing diagram illustrating an example of a block response frame transmission at different scheduled times by a Primary AP and a secondary AP;

FIG. 7 is a conceptual timing diagram illustrating an example of a block response frame transmission by a Secondary AP after a trigger frame;

FIG. 8 is a conceptual timing diagram illustrating an example of conveying an uplink transmission schedule to multiple wireless stations;

FIG. 9 is conceptual call flow sequence diagram illustrating an example of a cooperative reception setup driven by a wireless station;

FIG. 10 is a block diagram illustrating an example of a Primary AP response frame component;

FIG. 11 is a block diagram illustrating an example of a Secondary AP response frame component;

FIG. 12 is a block diagram illustrating an example of an uplink transmission and response frame controller in a wireless station;

FIG. 13 is a flow chart illustrating an example of aspects of a method for setting up cooperative reception;

FIG. 14 is a flow chart illustrating an example of aspects of a method for cooperative reception;

FIG. 15 is a flow chart illustrating an example of aspects of another method for cooperative reception;

FIG. 16 is a flow chart illustrating an example of aspects of yet another method for cooperative reception; and

FIG. 17 is a block diagram illustrating an example of a processing system for cooperative reception.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details.

The present disclosure provides various aspects for the use of inter-BSS cooperative diversity reception, also referred to simply as cooperative reception, to mitigate the effects of poor quality in the uplink transmission of a wireless station so that it is possible to effectively provide response block frames or messages to the wireless station. The terms “response frame” may be used in this disclosure to represent a digital transmission unit with a specified structure that is used to respond to transmitted data or information, to an inquiry, to a request, and/or to an event. In some instances, a response frame may be part of a message that may include additional information. An example of a response frame may be a “block response frame” such as a block acknowledgement (BA) frame sent in response to transmitted data. In block acknowledgment, instead of transmitting an individual acknowledgement (ACK) for every frame (e.g., data frame) that is sent, multiple frames can be acknowledged together using a single BA frame. When multiple frames are sent, the frames may be aggregated as, for example, uplink (UL) aggregated media access control (MAC) protocol data units (UL AMPDUs) data frames. In such cases, the block response frame may indicate which of the aggregate frames has been properly received (e.g., successfully demodulated and decoded).

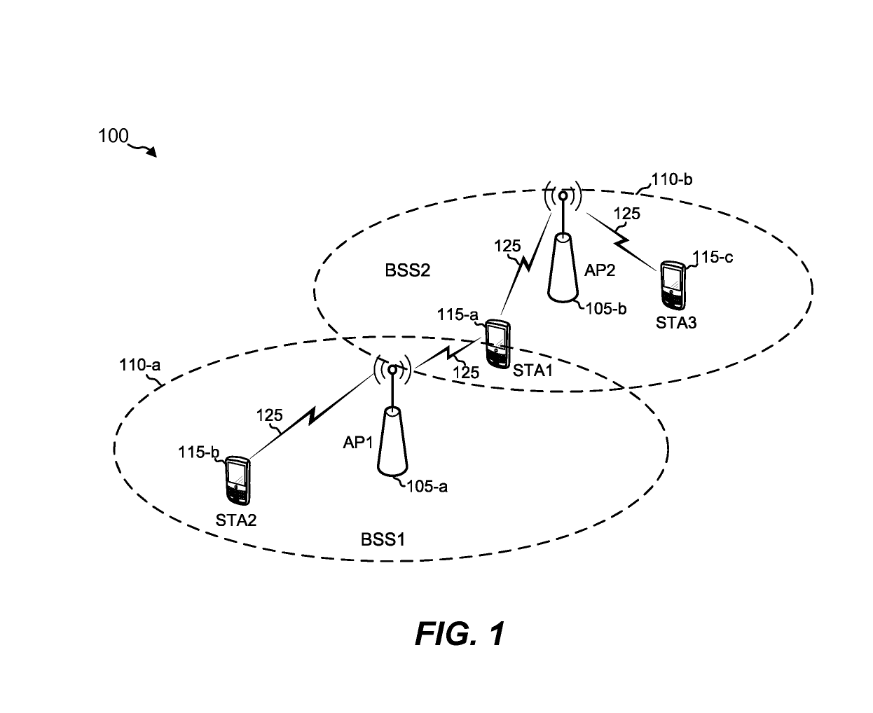

FIG. 1 is a conceptual diagram 100 illustrating an example of a wireless local area network (WLAN) deployment in connection with various techniques described herein for response frames in cooperative reception. The WLAN may include one or more access points (APs) and one or more mobile stations (STAs) associated with a respective AP. In this example, there are two APs deployed: AP1 105-a in basic service set 1 (BSS1) and AP2 105-b in BSS2. AP1 105-a is shown having at least two associated STAs (STA1 115-a and STA2 115-b) and coverage area 110-a, while AP2 105-b is shown having at least two associated STAs (STA1 115-a and STA3 115-c) and coverage area 110-b. In the example of FIG. 1, the coverage area of AP1 105-a overlaps part of the coverage area of AP2 105-b such that STA1 115-a is within the overlapping portion of the coverage areas. The number of BSSs, APs, and STAs, and the coverage areas of the APs described in connection with the WLAN deployment of FIG. 1 are provided by way of illustration and not of limitation. Moreover, aspects of the various techniques described herein for response frames in cooperative reception are based on the example WLAN deployment of FIG. 1 but need not be so limited.

The APs (e.g., AP1 105-a and AP2 105-b) shown in FIG. 1 are generally fixed terminals that provide backhaul services to STAs within its coverage area or region. In some applications, however, the AP may be a mobile or non-fixed terminal. The STAs (e.g., STA1 115-a, STA2 115-b and STA3 115-c) shown in FIG. 1, which may be fixed, non-fixed, or mobile terminals, utilize the backhaul services of their respective AP to connect to a network, such as the Internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, user equipment (UE), or some other suitable terminology. An AP may also be referred to as: a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Each of STA1 115-a, STA2 115-b, and STA3 115-c may be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications links 125. The APs can send frames to their respective STAs and receive frames from their respective STAs to communicate data and/or control information (e.g., signaling).

Each of AP1 105-a and AP2 105-b can establish a communications link 125 with an STA that is within the coverage area of the AP. Communications links 125 can comprise communications channels that can enable both uplink and downlink communications. When connecting to an AP, an STA can first authenticate itself with the AP and then associate itself with the AP. Once associated, a communications link 125 can be established between the AP and the STA such that the AP and the associated STA can exchange frames or messages through a direct communications channel.

While aspects for transmitting response frames using cooperative reception are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for transmitting response frames using cooperative reception may be applicable to any suitable wireless network regardless of the coverage range and the wireless access protocols utilized.

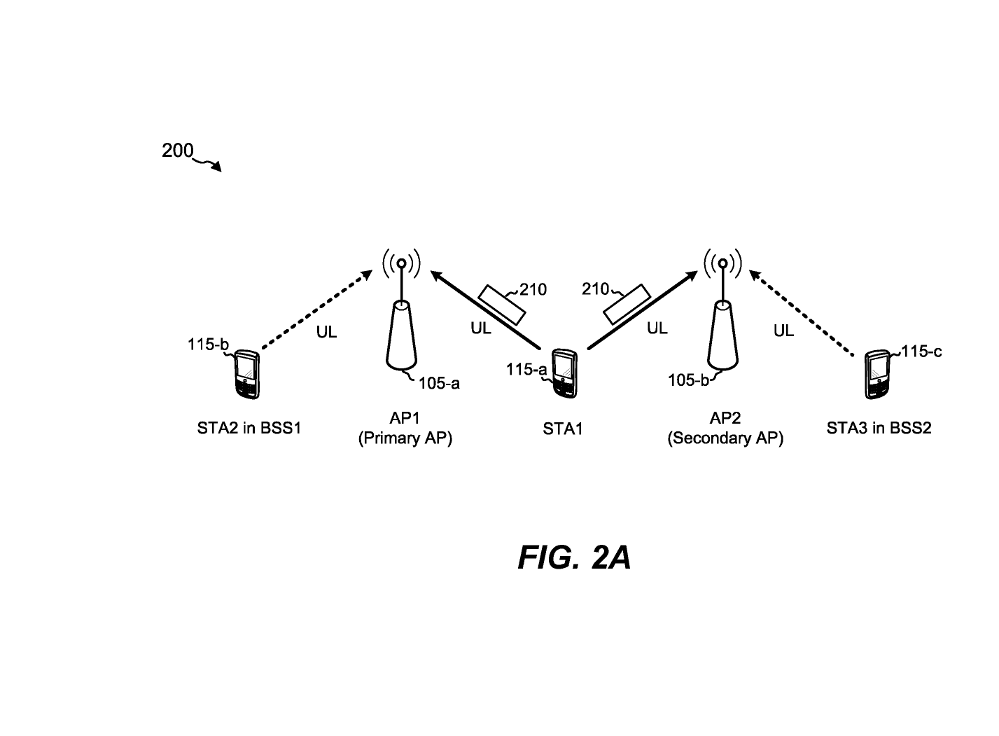

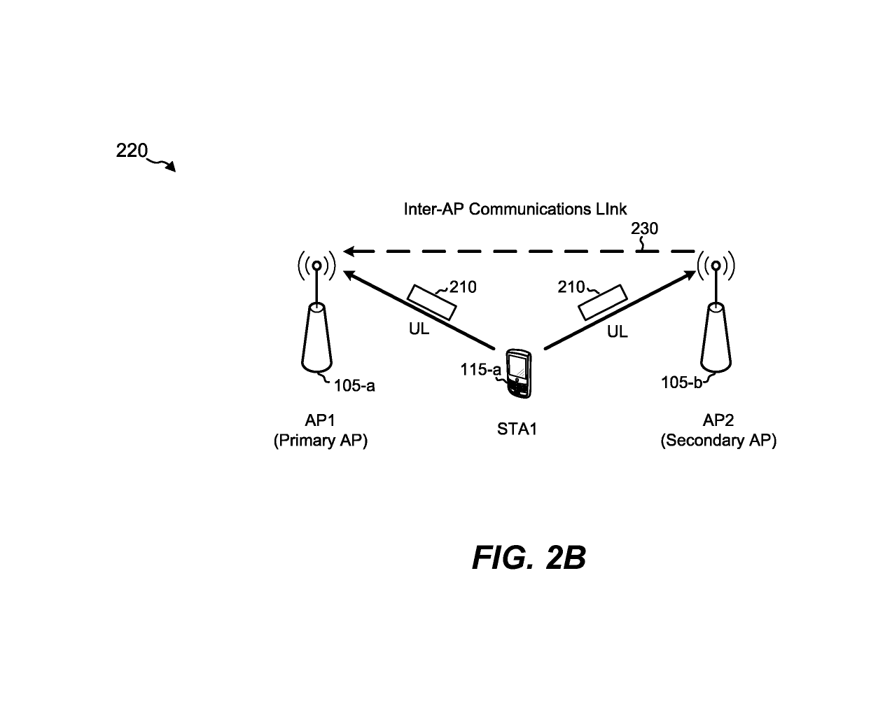

FIG. 2A shows a diagram 200 illustrating an example of a cooperative reception scenario. Diagram 200 generally describes a situation in which the UL transmissions received by an AP from an associated wireless station are of poor quality, especially when the wireless station is located at, for example, an edge of the coverage area (e.g., cell edge) of the AP. The poor quality of the UL transmissions may result from, for example, large path loss, fading, interference, or a combination of several of these factors. Because of poor quality of the UL transmissions, the data received by the AP may be corrupt or jammed and a proper response (e.g., acknowledgement) may not be provided to the wireless station. This may cause retransmissions or other procedures to be implemented that may add latency and/or reduce throughput. To mitigate these effects, an inter-BSS cooperative reception operation may be configured between two or more APs to allow an AP that has received good quality UL transmissions to forward data decoded from the UL transmissions to an AP that has otherwise received poor quality UL transmissions.

In the scenario of FIG. 2A, which is based on the WLAN deployment of FIG. 1, AP1 105-a (referred to as a Primary AP) may receive an UL frame 210 from STA1 115-a because STA1 115-a is within the coverage area of AP1 105-a (e.g., coverage area 110-a in FIG. 1). Reception of the UL frame 210 at AP1 105-a may be affected by interference associated with an UL transmission (shown by a dashed arrow) from STA2 115-b in BSS1. AP2 105-b (referred to as a Secondary AP) may also receive the UL frame 210 from STA1 115-a because STA1 115-a is within the coverage area of AP2 105-b (e.g., coverage area 110-b in FIG. 1). Reception of the UL frame 210 at AP1 105-b may be affected by interference associated with an UL transmission (shown by a dashed arrow) from STA3 115-c in BSS2.

Further to this scenario, the interference associated with the UL transmissions from STA2 115-b and STA3 115-c may be uncorrelated and time-varying. Thus, the UL frame 210 received by AP1 105-a may have been corrupted by interference from STA2 115-b, while the UL frame 210 received by AP2 105-b may not have been corrupted by interference from STA3 115-c. In such situation, AP2 105-b may be able to decode the UL frame 210 even when AP1 105-a is unable to do so. Once a cooperative reception operation (referred to simply as cooperative reception for the remaining of this disclosure) is established or configured between AP1 105-a in BSS1 (the Primary AP) and AP2 105-b in BSS2 (the Secondary AP), it is possible for AP2 105-b to forward data associated with the UL frame 210 to AP1 105-a. Once the data is received, AP1 105-a may process the data and may send a response frame (e.g., block response frame) to STA1 115-a indicating an acknowledgement of reception of the data associated with the UL frame 210.

FIG. 2B shows a diagram 220 illustrating an example of an inter-AP communications link associated with the cooperative reception of FIG. 2A. Diagram 220 shows the forwarding of UL data (e.g., decoded data from UL frame 210) from AP2 105-b (Secondary AP) to AP1 105-a (Primary AP) through an inter-AP communications link 230. The inter-AP communications link 230 may exist prior to establishing the cooperative reception between AP1 105-a and AP2 105-b or may be implemented as part of establishing the cooperative reception between AP1 105-a and AP2 105-b. The inter-AP communications link 230 may be via an over-the-air channel or via backhaul, and may include one or more third party nodes (not shown). As indicated above, by having AP2 105-b (Secondary AP) forward the UL data to AP1 105-a (Primary AP), then AP1 105-a may process the UL data and may send a response frame (e.g., block response frame) to STA1 115-a indicating an acknowledgement of reception of the UL data. In some instances, the sending of the response frame may be referred to as an acknowledgment (ACK) delivery in cooperative reception.

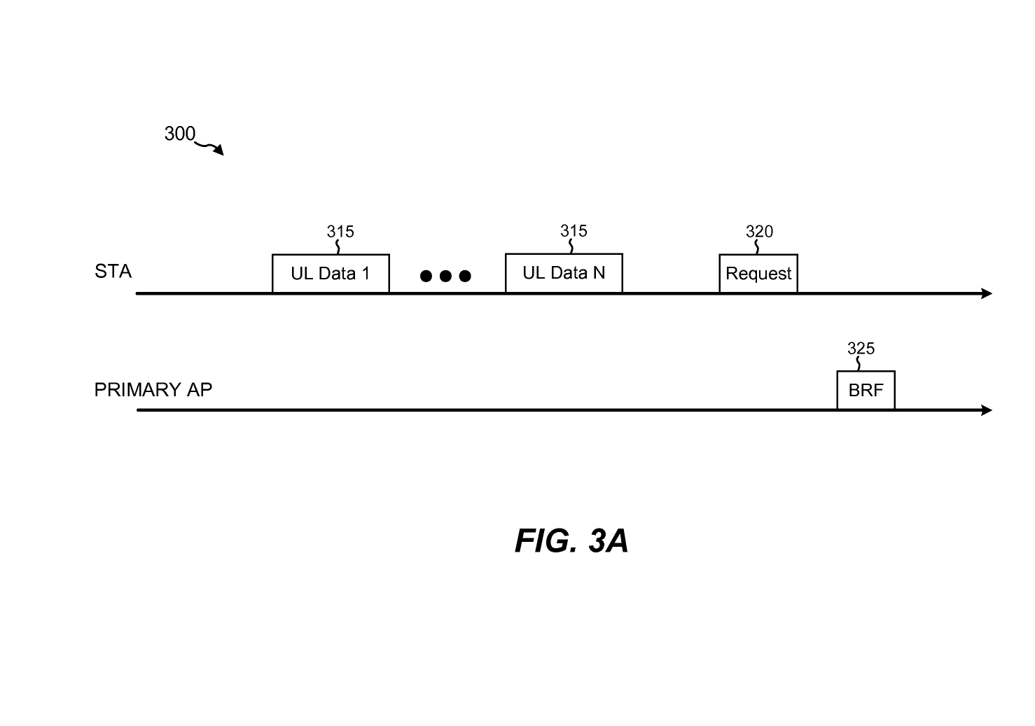

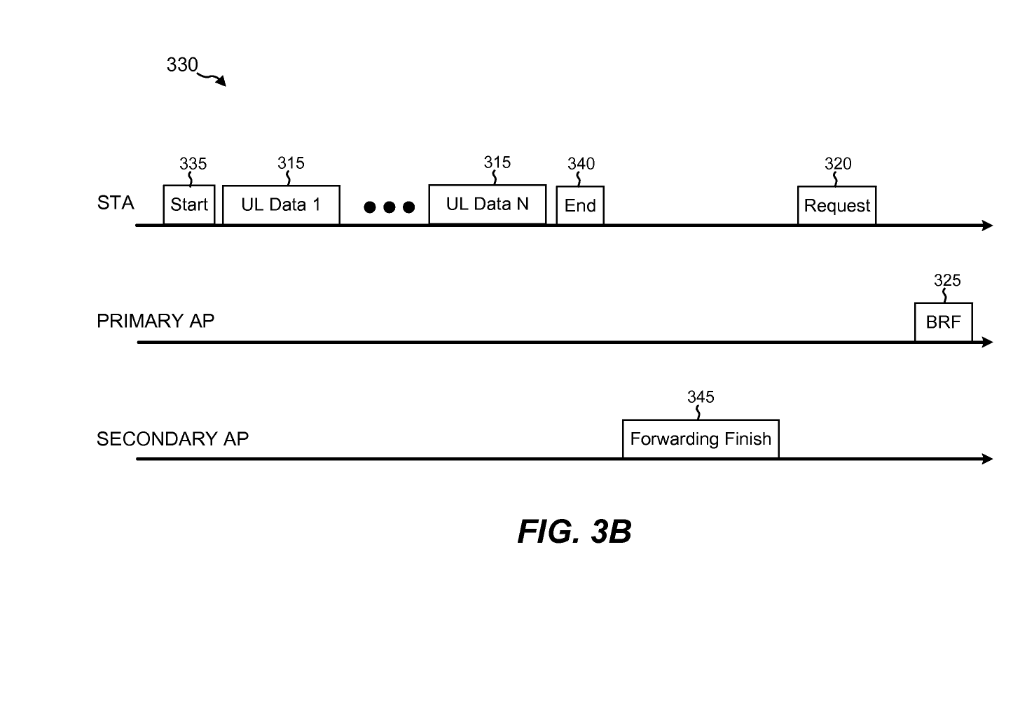

FIGS. 3A-8 are described below and provide details regarding various methods or approaches that may be used to send or deliver response frames (e.g., ACK frames, BA frames) in cooperative reception. In one type of method, response frames may be sent to an STA (e.g., STA transmitting UL frames) from one of multiple APs in cooperative reception. In another type of method, response frames may be sent to an STA (e.g., STA transmitting UL frames) from two or more APs from multiple APs in cooperative reception.

FIG. 3A shows a timing diagram 300 illustrating an example of a block response frame transmission by a Primary AP in response to a request by an STA. The timing diagram 300 may correspond to the type of method mentioned above in which a single AP sends or delivers response frames (e.g., block response frames) when multiple APs are in cooperative reception. In this case, the STA (e.g., STA1 115-a in FIGS. 1-2B) may send or transmit a sequence of uplink data frames 315 (e.g., UL Data 1, . . . , UL Data N) and may then send a request 320 (e.g., BA request or BAR) to the Primary AP (e.g., AP1 105-a in FIGS. 1-2B) for a block response frame (BRF) 325 (e.g., BA frame) on cooperative reception results. Cooperative reception results may refer to the forwarding of UL data (e.g., decoded UL MAC protocol data units (MPDUs)) from a Secondary AP (e.g., AP1 105-b in FIGS. 1-2B) to the Primary AP when the Secondary AP is in a cooperative reception operation with the Primary AP and when the Secondary AP is capable of producing (e.g., by decoding received UL MPDUs) the UL data after receiving the sequence of uplink data frames 315 (e.g., UL Data 1, . . . , UL Data N) from the STA.

In an aspect of FIG. 3A, the STA may have some knowledge of a time at which the UL data is likely to have been received by the Primary AP from the Secondary AP, and based on this knowledge, the STA may send the request 320 to the Primary AP some time after the UL data has been received by the Primary AP. In some aspects, the STA may wait for a few milliseconds to tens of milliseconds after the time at which the UL data is likely to have been received by the Primary AP to send the request 320. Once the request 320 is received, the Primary AP may send or deliver the BRF 325 to the STA, typically after a short interframe space (SIFS) duration.

FIG. 3B shows a timing diagram 330 illustrating an example of a request by an STA after an indication that decoded data has been forwarded to a Primary AP. The timing diagram 330 may correspond to the type of method mentioned above in which a single AP sends or delivers response frames (e.g., block response frames) when multiple APs are in cooperative reception. In this case, as in the case in FIG. 3A, the STA (e.g., STA1 115-a in FIGS. 1-2B) may send or transmit the sequence of uplink data frames 315 (e.g., UL Data 1, . . . , UL Data N) and may then send the request 320 (e.g., BA request or BAR) to the Primary AP (e.g., AP1 105-a in FIGS. 1-2B) for the BRF 325 (e.g., BA frame) on cooperative reception results with a Secondary AP (e.g., AP 105-b in FIGS. 1-2B).

In one aspect of FIG. 3B, to assist the STA know when the Secondary AP is done or finished forwarding the UL data to the Primary AP as part of the cooperative reception results, the Secondary AP may send an indication to the STA after forwarding to the Primary AP UL MPDUs received from the STA and successfully decoded by the Secondary AP. Those UL MPDUs received from the STA and not successfully decoded by the Secondary AP need not be forwarded to the Primary AP. In one example, the indication may be a frame such as a forwarding finish 345 shown in FIG. 3B. In such example, the STA may send the request 320 after receiving the forwarding finish 345 from the Secondary AP. In some aspects, the forwarding finish 345 may be sent in response to having all forwarded data acknowledged by the Primary AP and the STA may send the request 320 soon after the forwarding finish 345 is received.

In another aspect of FIG. 3B, to assist the Secondary AP determine when the forwarding of UL data (e.g., decoded UL MPDUs associated with UL Data 1, . . . , UL Data N) is done or finished, the STA may send a start frame (e.g., start 335) indicating the start of the sequence of uplink data frames 315 and an end frame (e.g., end 340) indicating the end of the sequence of uplink data frames 315. The Secondary AP may use the start frame and the end frame to identify the sequence of uplink data frames 315, which in turn allows the Secondary AP determine when the forwarding to the Primary AP is finished or completed. The start frame and the end frame may further indicate a data session index, and the forwarding finish 345 may also indicate the corresponding session index in the case. This may be useful when multiple sessions are active and there are sequences of uplink data frames associated with several active sessions that are being handled in a cooperative reception operation. In another aspect, the information being carried by the start frame and the end frame, including session index and related information, may be included in the uplink data frames 315 such that start 335 and end 340 need not be sent by the STA. In such a case, the information being carried by the start frame and the end frame may be included in a physical layer (PHY)/MAC header in one or more of the uplink data frames 315 in the sequence.

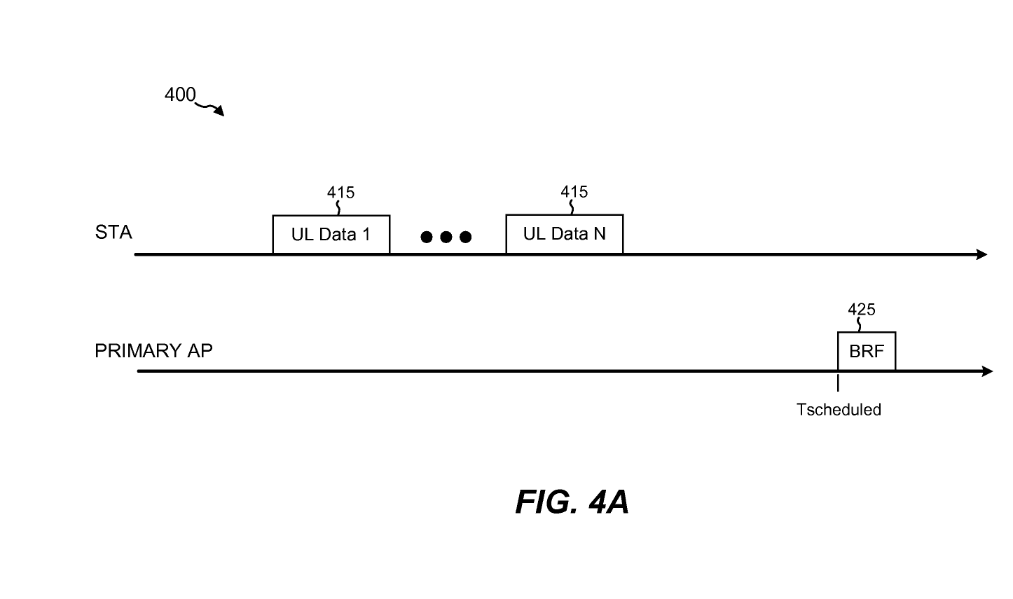

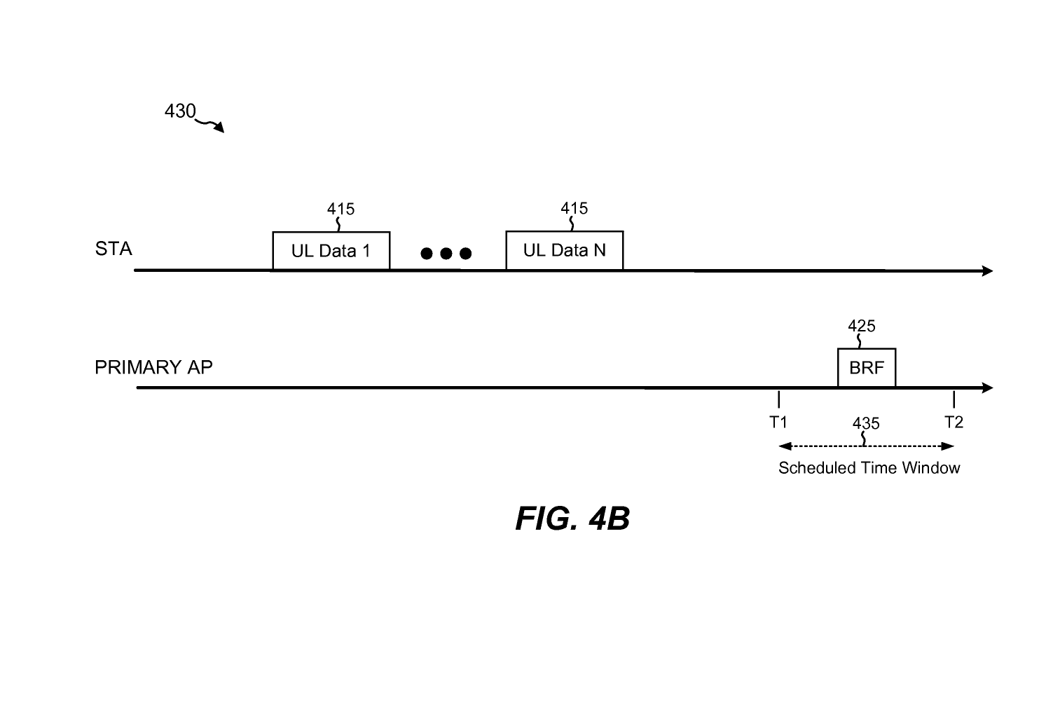

FIG. 4A shows a timing diagram 400 illustrating an example of a block response frame transmission by a Primary AP at a scheduled time. The scheduled time may be set by the Primary AP based on some initial or startup configuration or based on a configuration provided during operation of the Primary AP. The timing diagram 400 may correspond to the type of method mentioned above in which a single AP sends or delivers response frames (e.g., block response frames) when multiple APs are in cooperative reception. In this case, the STA (e.g., STA1 115-a in FIGS. 1-2B) may send or transmit a sequence of uplink data frames 415 (e.g., UL Data 1, . . . , UL Data N). The STA, however, may not send a request (e.g., BAR) to the Primary AP (e.g., AP1 105-a in FIGS. 1-2B) for the BRF 425 (e.g., BA frame) on cooperative reception results with a Secondary AP (e.g., AP 105-b in FIGS. 1-2B). Instead, the Primary AP may send the BRF 425 to the STA at a scheduled time (e.g., Tscheduled). In some aspects, the scheduled time may be about 15 milliseconds after the uplink data is transmitted by the STA, assuming that it may take approximately 10 milliseconds for the uplink data to be forwarded to the Primary AP over a backhaul connection.

In one aspect of FIG. 4A, transmission of the BRF 425 to the STA by the Primary AP may take place at the scheduled time without the Primary AP ever contending for a communications channel or medium (e.g., WLAN channel or medium) to make the transmission of the BRF 425.

In another aspect of FIG. 4A, transmission of the BRF 425 to the STA by the Primary AP may involve having the Primary AP first contend for a communications channel or medium (e.g., WLAN channel or medium) at the scheduled time to make the transmission of the BRF 425. Contention for a communications channel or medium may generally refer to the use of carrier sense multiple access (CSMA) techniques to verify the absence of other traffic before transmitting on a shared transmission medium.

FIG. 4B shows a timing diagram 430 illustrating an example of a block response frame transmission by a Primary AP during a scheduled time window. The scheduled time window (e.g., start and end values of the time window) may be set up or configured at the Primary AP based on some initial or startup configuration by a user or operator of the Primary AP, or based on a configuration change provided during operation of the Primary AP. The timing diagram 430 may also correspond to the type of method mentioned above in which a single AP sends or delivers response frames (e.g., block response frames) when multiple APs are in cooperative reception. In this case, the STA (e.g., STA1 115-a in FIGS. 1-2B) may send or transmit a sequence of uplink data frames 415 (e.g., UL Data 1, . . . , UL Data N). Like FIG. 4A, the STA may not send a request (e.g., BAR) to the Primary AP (e.g., AP1 105-a in FIGS. 1-2B) for the BRF 425 (e.g., BA frame) on cooperative reception results with a Secondary AP (e.g., AP 105-b in FIGS. 1-2B). Instead, the Primary AP may send the BRF 425 to the STA at any time within a scheduled time window 435 ([T1, T2]). In some aspects, the scheduled time window 435 may range from 15 milliseconds to 30 milliseconds after the uplink data is transmitted by the STA.

In one aspect of FIG. 4B, the BRF 425 may be transmitted by the Primary AP within the scheduled time window 435 after the decoded UL MPDUs associated with the last UL data frame 415 in the sequence (e.g., UL Data N) has been forwarded to the Primary AP by the Secondary AP. In another aspect of FIG. 4B, the Primary AP may update the start and end values of the scheduled time window 435 (e.g., T1, T2) based at least in part on a current data forwarding delay from the Secondary AP. The updated start and end values may be signaled to the STA by the Primary AP for power savings applications. For example, by signaling the updated start and end values of the scheduled time window 435, the STA may be dormant or operating in a low power mode before the arrival of the updated time window where the STA needs to wake up to check for the BRF 425.

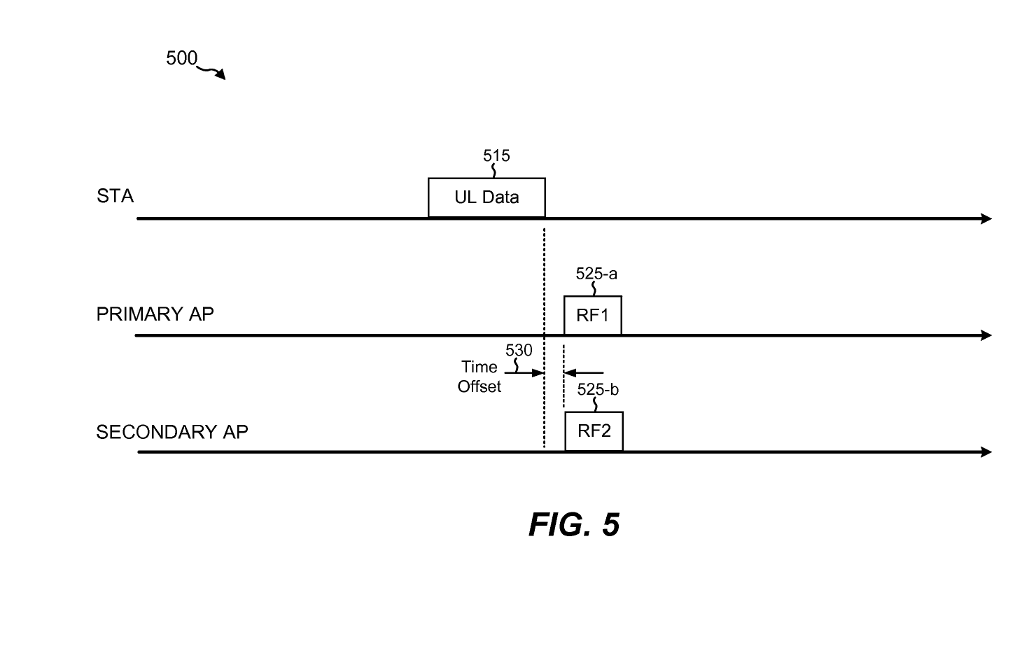

FIG. 5 shows a timing diagram 500 illustrating an example of a response frame transmission at a same time by each of a Primary AP and a Secondary AP. The timing diagram 500 may correspond to the type of method mentioned above in which two or more APs send or deliver response frames (RFs) when multiple APs are in cooperative reception. In this case, the STA (e.g., STA1 115-a in FIGS. 1-2B) may send or transmit an uplink data frame 515 (e.g., UL Data). The STA may not send a request to the Primary AP (e.g., AP1 105-a in FIGS. 1-2B) or to the Secondary AP (e.g., AP2 105-b in FIGS. 1-2B) for acknowledgement of the cooperative reception results. Instead, when both the Primary AP and the Secondary AP successfully receive the uplink data frame 515, they will both send a common response frame to the STA after a fixed interval (e.g., time offset 530) from the time the uplink data frame 515 is received by the two APs. For example, the Primary AP may send an RF1 525-a (e.g., ACK frame) to the STA a time offset 530 after receiving the uplink data frame 515, while the Secondary AP may send an RF2 525-b (e.g., ACK frame) to the STA a time offset 530 after receiving the uplink data frame 515, where RF1 525-a and RF2 525-b are a common response frame sent by two different APs. In this example, the time offset 530 may have a duration of a short interframe space (SIFS), which is 16 microseconds.

In one aspect of FIG. 5, the common response frames (RF1 525-a and RF2 525-b) may have a common frame format and may be perceived by the STA as multi-path versions of the same response frame (e.g., ACK frame). As such, the STA can receive RF1 525-a and RF2 525-b without them causing interference with each other.

In another aspect of FIG. 5, the Primary AP and the Secondary AP may negotiate for the common response frame during setup (e.g., configuration) of the cooperative reception operation. The common response frame may be negotiated to be a non-high throughput (non-HT) response frame (e.g., non-HT ACK frame) having the same format, that is, having the same frame control, duration, address fields, modulation and coding scheme (MCS), and payload scrambling seed. The negotiation may also restrict the uplink data frame 515 to a single MPDU if the non-HT response frame is used as the common response frame. Moreover, the Secondary AP that sends the RF2 525-b to the STA need to also forward the decoded UL data from the uplink data frame 515 to the Primary AP. The decoded UL data may be forwarded to the Primary AP at the same time as the RF2 525-b is sent to the STA.

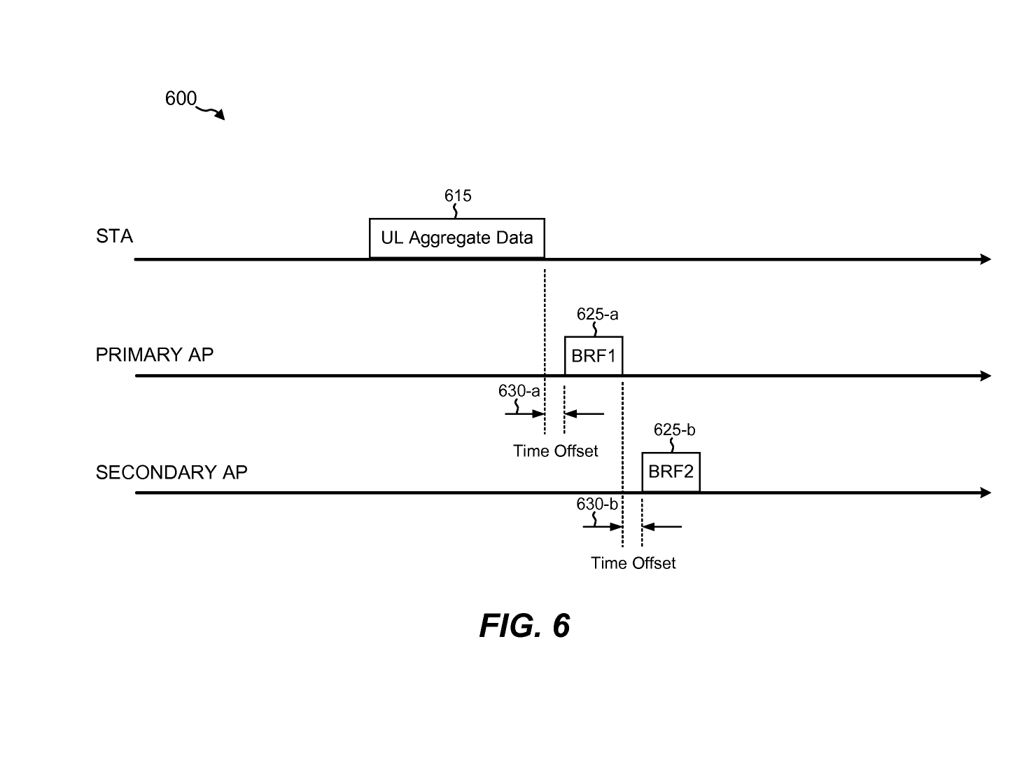

FIG. 6 shows timing diagram 600 illustrating an example of a block response frame transmission at different times by a Primary AP and a Secondary AP. The timing diagram 600 may correspond to the type of method mentioned above in which two or more APs send or deliver response frames (e.g., block response frames) when multiple APs are in cooperative reception. In this case, the STA (e.g., STA1 115-a in FIGS. 1-2B) may send or transmit an uplink aggregate data frame 615 (e.g., UL Aggregate Data). The uplink aggregate data frame 615 may include, for example, an UL AMPDU data frame. The STA may not send a request to the Primary AP (e.g., AP1 105-a in FIGS. 1-2B) or to the Secondary AP (e.g., AP2 105-b in FIGS. 1-2B) for acknowledgement of the cooperative reception results. Instead, when both the Primary AP and the Secondary AP successfully receive the uplink aggregate data frame 615, they will both send a block response frame to the STA at a scheduled time or time slots. For example, the Primary AP may send a BRF1 625-a (e.g., BA frame) to the STA a time offset 630-a after receiving the uplink aggregate data frame 615, while the Secondary AP may send a BRF2 625-b (e.g., BA frame) to the STA a time offset 630-b after BRF1 625-a is received by the STA. In this example, the time offsets 630-a and 630-b may each have a duration of SIFS, which is 16 microseconds.

In one aspect of FIG. 6, the scheduled times at which BRF1 625-a and BRF2 625-b are transmitted may be determined by the STA or the Primary AP, and may be informed or communicated to cooperative APs at the time the cooperative reception is set up or configured, or by sending such information in UL data frames. For example, the STA may update a network allocator vector (NAV) in an UL data frame to include the scheduling information for the block response frames for the various APs. Moreover, the Secondary AP that sends the BRF2 625-b to the STA need to also forward the decoded UL data (e.g., decoded MPDUs) from the uplink aggregate data frame 615 to the Primary AP. The decoded UL data may be forwarded to the Primary AP at the same time as the BF2 625-b is sent to the STA.

In another aspect of FIG. 6, while the BRF1 625-a is shown to be transmitted by the Primary AP before the BRF2 625-b is transmitted by the Secondary AP, the disclosure need not be so limited and the order in which the block response frames are sent may be different. In addition, when there are multiple Secondary APs as part of the cooperative reception, there may be different ways in which the block response frames from the Primary AP and the multiple Secondary APs are scheduled for transmission. In some cases, the block response frame from the Primary AP may be sent last.

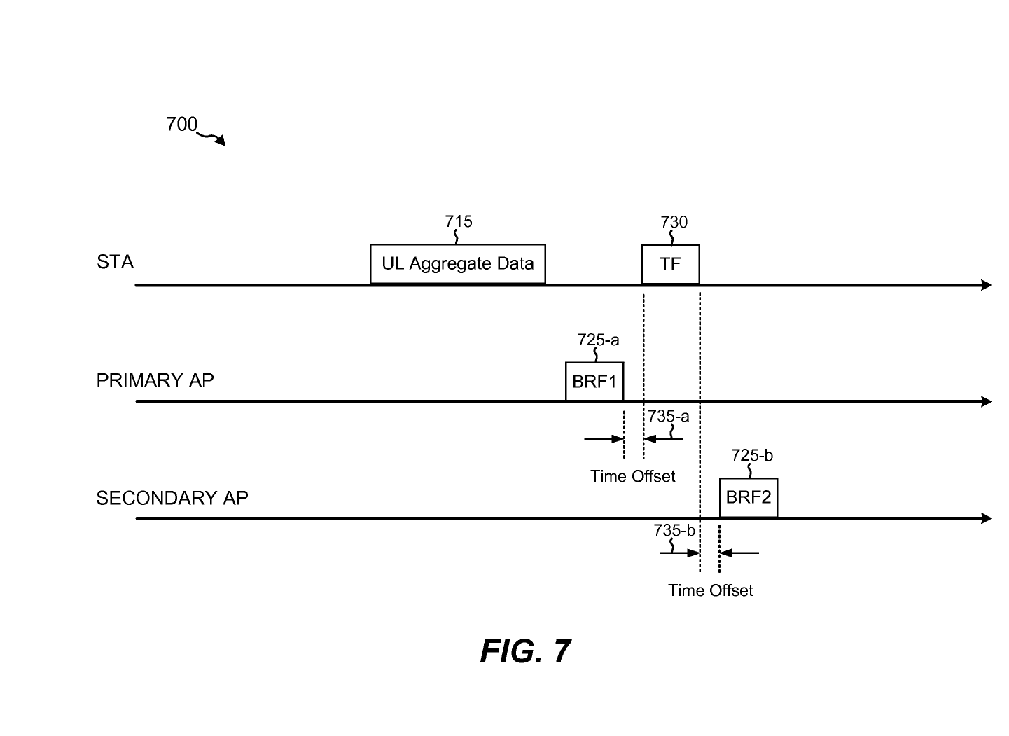

FIG. 7 shows a timing diagram 700 illustrating an example of a block response frame transmission by a Secondary AP after a trigger frame. The timing diagram 700 may correspond to the type of method mentioned above in which two or more APs send or deliver response frames (e.g., block response frames) when multiple APs are in cooperative reception. In this case, the STA (e.g., STA1 115-a in FIGS. 1-2B) may send or transmit an uplink aggregate data frame 715 (e.g., UL Aggregate Data). The uplink aggregate data frame 75 may include, for example, an UL AMPDU data frame. The STA may not send a request to the Primary AP (e.g., AP1 105-a in FIGS. 1-2B) or to the Secondary AP (e.g., AP2 105-b in FIGS. 1-2B) for acknowledgement of the cooperative reception results. Instead, the Primary AP will send a block response frame after each UL data frame. In this case, the Primary AP will typically send a BRF1 725-a (e.g., BA frame) after the uplink aggregate data frame 75 is received by the Primary AP. However, if all the MPDUs in the uplink aggregate data frame 75 fail decoding at the Primary AP and no BRF1 725-a is sent, or if most of the MPDUs in the uplink aggregate data frame 75 fail decoding (e.g., at least 50%) at the Primary AP and BRF1 725-a reflects this level of decoding failure, then the STA will send a trigger frame (TF) 730 to schedule one or more Secondary APs to send block response frames. The TF 730 may be sent by the STA a time offset 735-a after the BRF1 725-a is received by the STA from the Primary AP. Once the TF 730 is received by the Secondary AP, the Secondary AP may send a BRF2 725-b (e.g., BA frame) to the STA a time offset 735-b after the TF 730 is received by the Secondary AP. The time offsets 735-a and 735-b may each have a duration of SIFS, which is 16 microseconds.

In an aspect of FIG. 7, by making use of the TF 730, the Secondary AP (or Secondary APs when there is more than one) may opportunistically send block response frames (e.g., BA frames) to the STA in response to a determination that at least most of the MPDUs or MAC service data units (MSDUs) failed decoding (e.g., >50% failure) at the Primary AP. In some instances, the TF 730 may include a schedule for the transmission of block response frames when there is more than one Secondary AP in cooperative reception. The STA may also set NAV in accordance with the schedule. Moreover, the TF 730 may include information about the block response results from the Primary AP (e.g., information about BRF1 725-a), and the Secondary AP(s) may use this information to identify and forward to the Primary AP only those decoded MPDUs corresponding to the MPDUs that failed decoding at the Primary AP.

While the various techniques described so far for response frames in cooperative reception have relied on the forwarding of UL data from a Secondary AP to a Primary AP, the disclosure need not be so limited. In another aspect of the disclosure, which is applicable to the methods and apparatuses described herein, a Secondary AP may forward to a Primary AP a decoded UL block response frame (e.g., decoded UL BA frame) from an STA to improve reliability of the operation. In one scenario, the STA may be experiencing high block response frame packet error rate (PER) (e.g., PER >20%) and may set an indicator in an uplink block response frame to convey this condition. Any Secondary AP participating in the cooperative reception operation may forward the decoded uplink block response frame to the Primary AP after detecting this indicator.

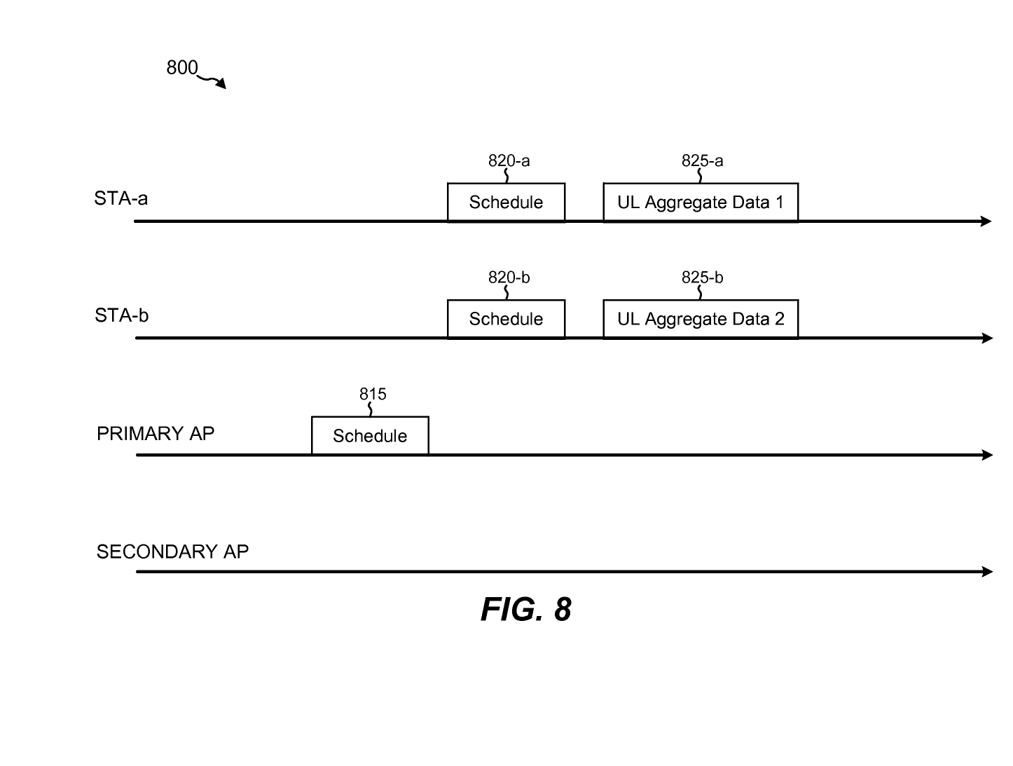

FIG. 8 shows a timing diagram 800 illustrating an example of conveying an uplink transmission schedule to multiple STAs. In the timing diagram 800, a Primary AP may send an uplink transmission schedule frame to multiple STAs. For example, the Primary AP (e.g., AP1 105-a in FIGS. 1-2B) may send a schedule 815 to STA-a (e.g., STA1 105-a in FIGS. 1-2B) and STA-b (e.g., STA2 105-b in FIGS. 1-2B). The schedule 815 may indicate the allocation of resources for each of STA-a and STA-b. The schedule 815 may include uplink transmission scheduling information such as but not limited to time, frequency, spatial stream allocations, MCS, and data length for each STA identifier (ID).

One issue that may arise in the scenario described in FIG. 8 is that a Secondary AP (e.g., AP1 105-b in FIGS. 1-2B) in cooperative reception with the Primary AP may not receive the schedule 815 from the Primary AP. One reason for this to happen may be that the Secondary AP is located outside the coverage area of the Primary AP. Without the information in the schedule 815, the Secondary AP may not be able to decode the UL data from the STAs if the uplink transmission scheduling information is not repeated in the UL data because of compression.

An approach to address this issue may be to have each of STA-a and STA-b repeat the schedule 815. This is shown in FIG. 8 by the STA-a repeating the information in schedule 815 through the transmission of a schedule 820-a, and by STA-b repeating the information in schedule 815 through the transmission of a schedule 820-b. Schedule 820-a and/or schedule 820-b may be received by the Secondary AP to enable the Secondary AP to decode UL data from the STA-a and the STA-b. After the uplink transmission scheduling information is repeated, STA-a may transmit an uplink aggregate data frame 825-a (e.g., UL Aggregate Data 1) associated with a first spatial stream allocation and STA-b may transmit an uplink aggregate data frame 825-b (e.g., UL Aggregate Data 2) associated with a second spatial stream allocation. Each of the uplink aggregate data frames 825-a and 825-b may include, for example, an UL AMPDU data frame.

In an aspect of the approach described above, schedule 820-a and schedule 820-b may include the uplink transmission scheduling information in a common frame format used by both STA-a and STA-b. In another aspect, instead of transmitting schedule 820-a and schedule 820-b, STA-a and STA-b may include the uplink transmission scheduling information in common preamble format in the UL data frames (e.g., uplink aggregate data frame 825-a, uplink aggregate data frame 825-b). Whether the uplink transmission scheduling information is provided by sending schedule 820-a and schedule 820-b, or by including the information in the UL data frames, may be indicated by the Primary AP in the schedule 815.

The cooperative reception described in the timing diagrams of FIGS. 3A-8 and in other portions of this disclosure may be set up or configured by an STA (e.g., STA1 115-a in FIGS. 1-2B) or by an AP (e.g., AP1 105-a in FIGS. 1-2B). When set up or configured by the STA, the operation may be referred to as an STA-driven cooperative reception setup. When set up or configured by the AP, the operation may be referred to as an AP-driven cooperative reception setup.

In an aspect of an STA-driven cooperative reception setup, the STA may send an indicator in an action frame or in a PHY/MAC header of a data frame, where the indicator may specify whether cooperative reception is to be “ON” (e.g., enabled) or “OFF” (e.g., disabled). The STA may set the indicator to specify that cooperative reception is to be “ON” when a metric is less than a predetermined threshold. For example, when a signal strength metric such as received signal strength indication (RSSI) is less than a predetermined threshold (e.g., RSSI <−75 dBm), the STA may set the indicator to specify that cooperative reception is to be “ON”. In another example, when a link quality metric such as UL throughput is less than a predetermined threshold, the STA may also set the indicator to specify that cooperative reception is to be “ON”. When an AP in an OBSS to the BSS of the STA detects the indicator sent by the STA, the AP may be configured to forward decoded data to a Primary AP, which may also be specified in the indicator. In addition, the STA may specify a set of OBSS APs in the indicator, and those selected OBSS APs may be configured to forward decoded data to the Primary AP. An OBSS AP not part of the set specified in the indicator may not be configured to forward decoded data to the Primary AP.

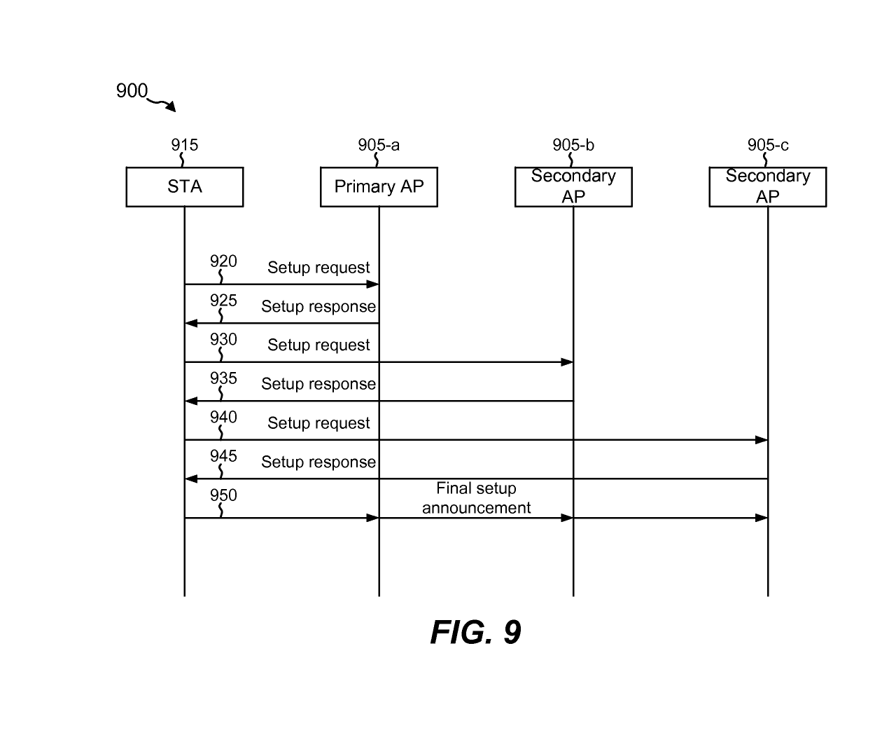

Another aspect of an STA-driven cooperative reception setup is described in connection with FIG. 9. FIG. 9 shows call flow sequence diagram 900 illustrating an example in which an STA 915 (e.g., STA1 115-a in FIGS. 1-2B) uses a setup request and response sequence to set up or configure cooperative reception. The STA 915 may send a setup request 920 to a Primary AP 905-a (e.g., AP1 105-a in FIGS. 1-2B), which in turn may send a setup response 925 back to the STA 915. The STA 915 may also send a setup request to each candidate Secondary AP, which in turn sends back a setup response if the candidate Secondary AP accepts to participate in the cooperative reception operation. In the example shown in FIG. 9, the STA 915 may send a setup request 930 to a Secondary AP 905-b (e.g., AP2 105-b in FIGS. 1-2B), which in turn may send a setup response 935 back to the STA 915. In addition, the STA 915 may send a setup request 940 to a Secondary AP 905-c (e.g., AP2 105-b in FIGS. 1-2B), which in turn may send a setup response 945 back to the STA 915. The STA 915 may then select a set of Secondary APs and may send them, and the Primary AP 905-a, a final setup announcement 950 that may include a common response frame format (e.g., common BA format) and a response frame schedule (e.g., BA schedule) as described above. In some instances, the final setup announcement 950 may also include a common encryption key that may be used by the APs to decode the UL data sent from the STA 915.

In an aspect of the STA-driven cooperative reception setup of FIG. 9, a candidate Secondary AP may accept to be part of the setup or configuration of the cooperative reception operation when there is an inter-AP communications link (e.g., inter-AP communications link 230 in FIG. 2B) between the candidate Secondary AP and the Primary AP 905-a. Moreover, the STA may select the set of Secondary APs based on which APs have a load that is less than a predetermined threshold (e.g., load <30%), as indicated by the beacon of the respective AP.

In an aspect of an AP-driven cooperative reception setup, an AP (e.g., AP1 105-a in FIGS. 1-2B) may identify an STA (e.g., STA1 105-a in FIGS. 1-2B) that has a poor signal strength metric (e.g., RSSI <Signal Strength Threshold (e.g., RSSI <−75 dBm)) or a poor link quality metric (e.g., UL throughput <Link Quality Threshold). The AP may request that the STA report back to the AP a set of candidate Secondary APs with good signal strength metric (e.g., RSSI) to the STA. The AP may then send a request to each candidate Secondary AP in the set and later sends a final setup announcement (see e.g., to those Secondary APs that accepted participation in the cooperative reception operation. Communication between the AP and the Secondary APs may take place over an inter-AP communications link (e.g., inter-AP communications link 230 in FIG. 2B).

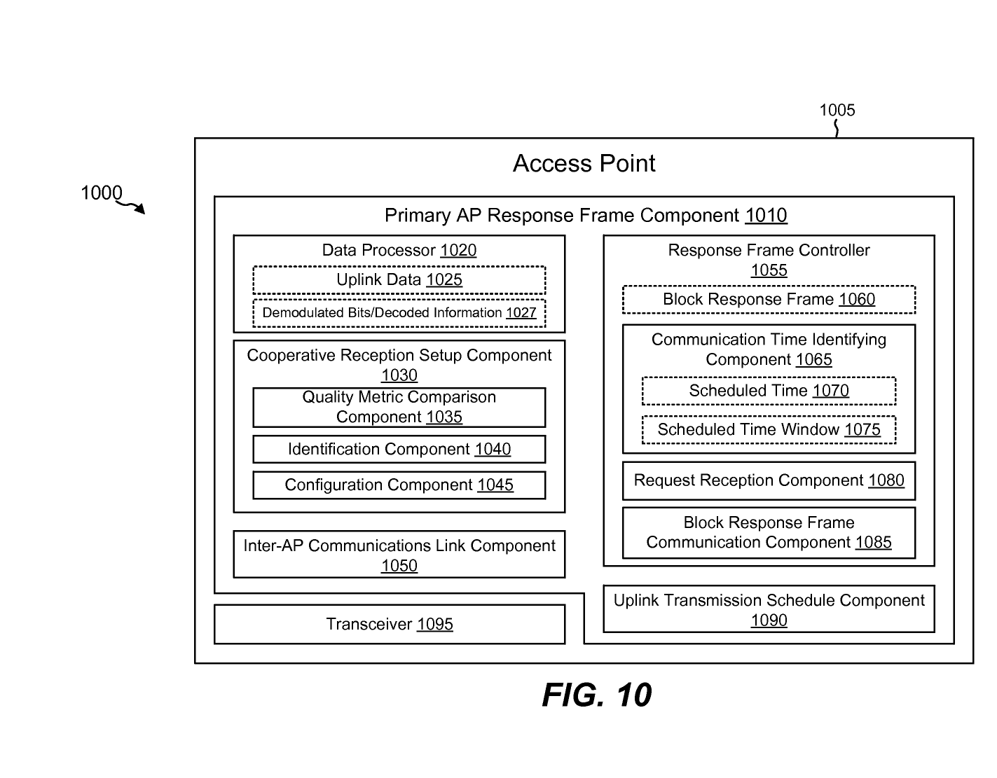

Referring to FIGS. 10-15, aspects of the present disclosure are depicted with reference to one or more components and one or more methods that may perform the actions or functions described herein. Although the actions or function described below are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions. Moreover, in an aspect, a component may be one of the parts that make up a system, may be hardware, software, or a combination of hardware and software, and/or may be divided into other components.

FIG. 10 shows a block diagram 1000 illustrating an example of a Primary AP response frame component 1010. An access point 1005 may be an example of the Primary APs described in FIGS. 2A-9 of this disclosure. The access point 1005 may include the Primary AP response frame component 1010, which in turn has a data processor 1020, a cooperative reception setup component 1030, an inter-AP communications link component 1050, a response frame controller 1055, and an uplink transmission schedule component 1090. The access point 1005 may also include a transceiver 1095 configured to transmit and receive information (e.g., data, control information) from one or more wireless stations and/or from one or more other access points.

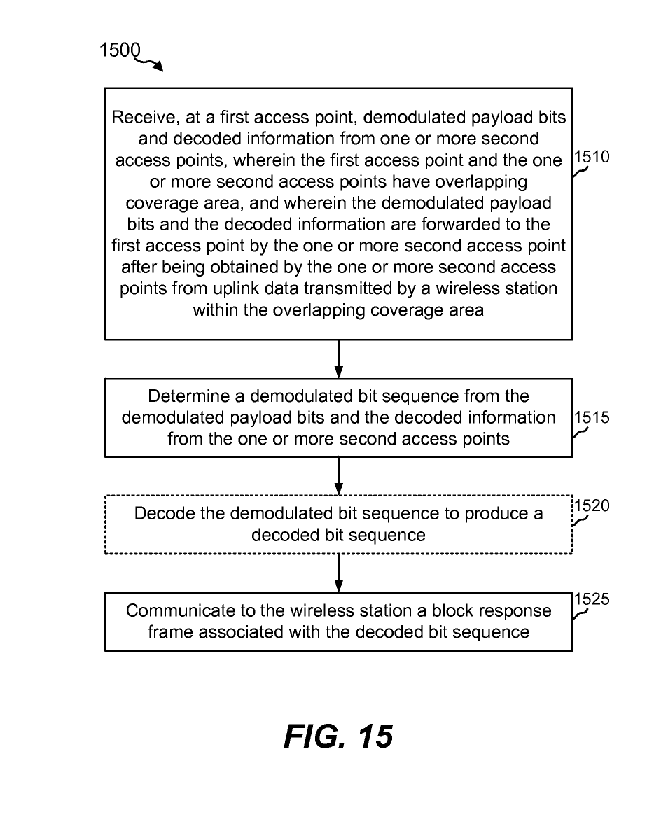

The data processor 1020 may be configured to process uplink data 1025 and/or demodulated bits/decoded information 1027 received from a Secondary AP. In the case of the demodulated bits/decoded information 1027, the data processor 1020 may be configured to perform aspects of the method 1500 described below with respect to FIG. 15.

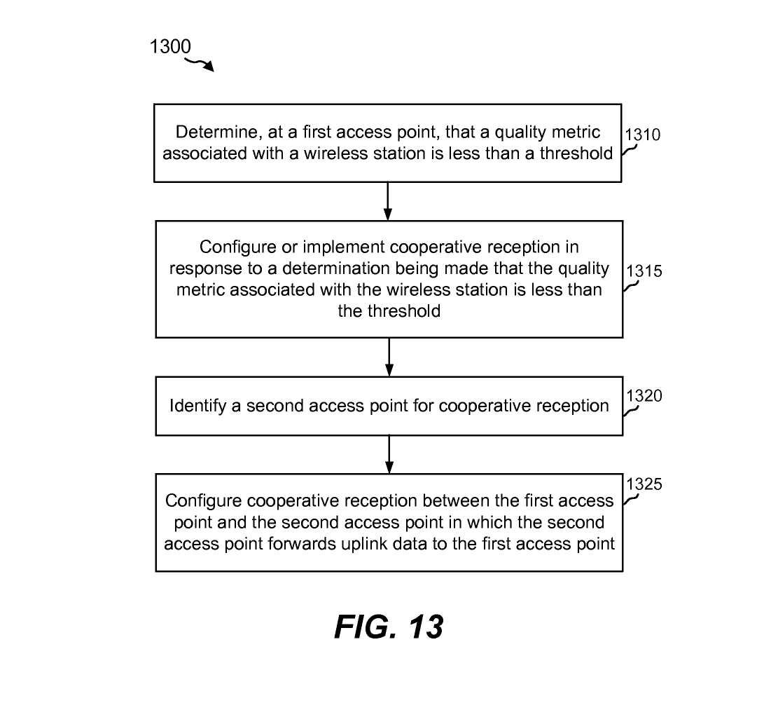

The cooperative reception setup component 1030 may be configured to support aspects of STA-driven cooperative reception setup and/or AP-driven cooperative reception setup. For AP-driven cooperative reception setup, the cooperative reception setup component 1030 may include a quality metric comparison component 1035, an identification component 1040, and a configuration component 1045, which may configured to perform aspects of the method 1300 described below with respect to FIG. 13.

The inter-AP communications link component 1050 may be configured to establish, maintain, and/or use an inter-AP communications link (e.g., inter-AP communications link 230 in FIG. 2B). The inter-AP communications link component 1050 along with the transceiver 1095 may be configured to send and receive information from another access point.

The response frame controller 1055 may be configured to handle various aspects of sending a response frame (e.g., block response frame 1060 such as a BA frame) to a wireless station to provide cooperative reception results to the wireless station. The response frame controller 1055 may include a communication time identifying component 1065, a request reception component 1080, and a block response frame communication component 1085.

The time identifying component 1065 may be configured to identify a scheduled time 1070 and/or a scheduled time window 1075. The time identifying component 1065 may be configured to support aspects described above in connection with at least FIGS. 4A and 4B.

The request reception component 1080 may be configured to receive a request from a wireless station to have cooperative reception results provided to the wireless station. The request reception component 1080 may be configured to support aspects described above in connection with at least FIGS. 3A and 3B.

The block response frame communication component 1085 may be configured to transmit response frames, including block response frames (e.g., BA frames) to a wireless station. The response frames may provide cooperative reception results to the wireless station in accordance with either a request handled by the request reception component 1080 or a scheduled time/scheduled time window handled by the communication time identifying component 1065. The block response frame communication component 1085 along with the transceiver 1095 may be configured to transmit the response frames to the wireless station.

The uplink transmission schedule component 1090 may be configured to provide a schedule to one or more wireless stations. The uplink transmission schedule component 1090 may be configured to support aspects described above in connection with at least FIG. 8.

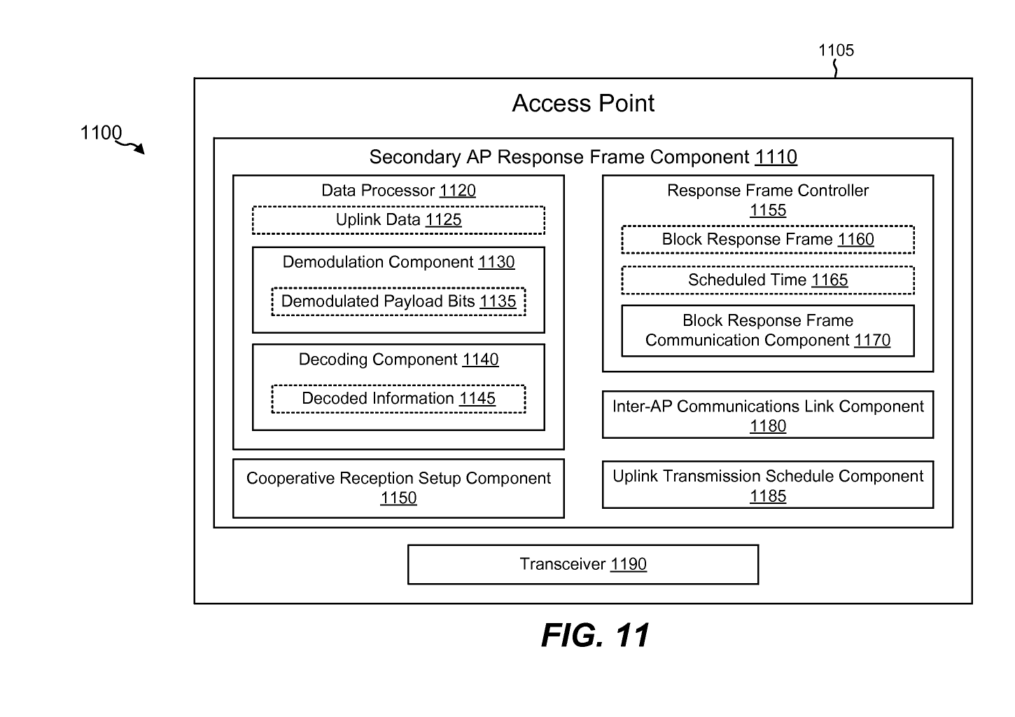

FIG. 11 shows a block diagram 1100 illustrating an example of a Secondary AP response frame component 1110. An access point 1105 may be an example of the Secondary APs described in FIGS. 2A, 2B, 3B, and 5-9 of this disclosure. The access point 1105 may include the Secondary AP response frame component 1110, which in turn has a data processor 1120, a cooperative reception setup component 1150, an inter-AP communications link component 1180, a response frame controller 1155, and an uplink transmission schedule component 1185. The access point 1105 may also include a transceiver 1190 configured to transmit and receive information (e.g., data, control information) from one or more wireless stations and/or from one or more other access points.

The data processor 1120 may be configured to process uplink data 1125 that is to be forwarded to a Primary AP. The data processor 1120 may include a demodulation component 1130 configured to demodulate payload bits from MPDUs to produce demodulated bits 1135. The demodulation component 1130 may include a decoding component 1140 configured to decode demodulated information from MPDU headers (e.g., PHY/MAC headers) to produce decoded information 1145. In the case of the demodulated bits 1135 and the decoded information 1145, the data processor 1020 may be configured to perform those aspects of the method 1500 described below with respect to FIG. 15 that are related to Secondary APs.

The cooperative reception setup component 1150 may be configured to support aspects of STA-driven cooperative reception setup and/or AP-driven cooperative reception setup that are related to Secondary APs.

The inter-AP communications link component 1180 may be configured to establish, maintain, and/or use an inter-AP communications link (e.g., inter-AP communications link 230 in FIG. 2B). The inter-AP communications link component 1180 along with the transceiver 1190 may be configured to send and receive information from another access point.

The response frame controller 1155 may be configured to handle various aspects of sending a response frame (e.g., block response frame 1160 such as a BA frame) to a wireless station. The response frame controller 1155 may sometimes transmit the block response frame 1160 at a scheduled time 1165. The response frame controller 1155 may be configured to support aspects described above in connection with at least FIGS. 6 and 7 that are related to Secondary APs. The response frame controller 1155 may include a block response frame communication component 1170, which along with the transceiver 1095, may be configured to transmit response frames to the wireless station.

The uplink transmission schedule component 1185 may be configured to receive a schedule repeated by one or more wireless stations. The uplink transmission schedule component 1185 may be configured to support aspects described above in connection with at least FIG. 8 that are related to Secondary APs.

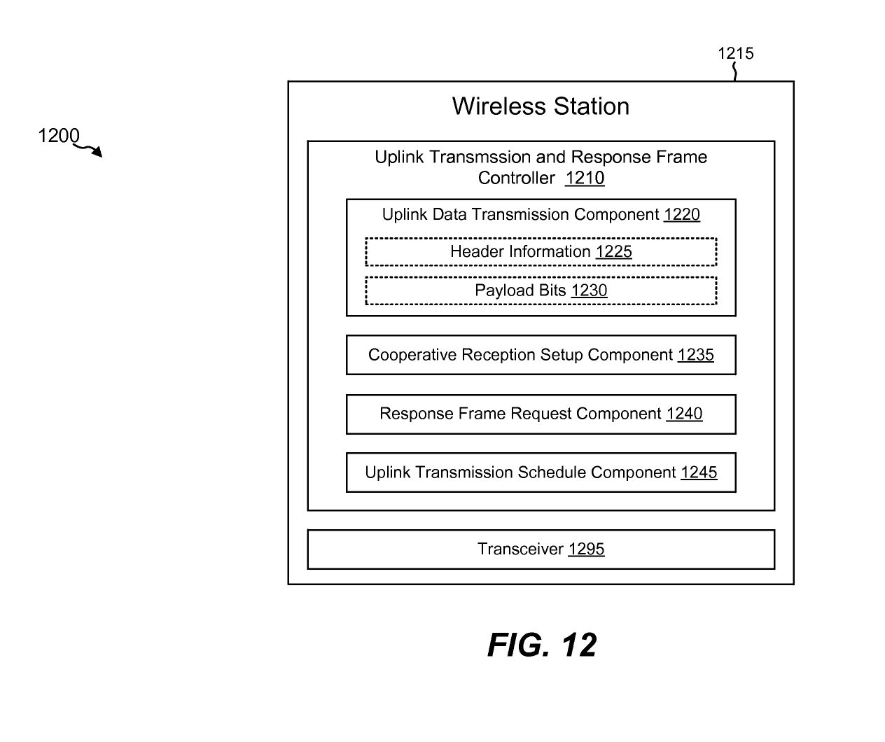

FIG. 12 shows a block diagram 1200 illustrating an example of an uplink transmission and response frame controller 1210 in a wireless station. A wireless station 1215 may be an example of the STAs described in FIGS. 1-9 of this disclosure. The wireless station 1215 may include the uplink transmission and response frame controller 1210, which in turn has an uplink data transmission component 1220, a cooperative reception setup component 1235, a response frame request component 1240, and an uplink transmission schedule component 1245. The uplink transmission and response frame controller 1210 may also include a transceiver 1295 configured to transmit and receive information (e.g., data, control information) from one or more access points.

The uplink data transmission component 1220 may be configured to handle various aspects of sending uplink transmissions (e.g., UL data, UL aggregate data). In some cases, when cooperative reception involves the forwarding of demodulated MPDU payload bits and decoded MPDU information, the uplink data transmission component 1220 may be configured to encode the MPDU information in a PHY or MAC header to produce header information 1225, and separately encode the MPDU payload bits to produce payload bits 1230. A Secondary AP that receives the header information 1225 and the payload bits 1230 may process them differently than if the MPDU information and MPDU payload bits had been encoded together.

The cooperative reception setup component 1235 may be configured to support aspects of STA-driven cooperative reception setup and/or AP-driven cooperative reception setup that are related to a wireless station.

The response frame request component 1240 may be configured to send a request to a Primary AP to have cooperative reception results provided by the Primary AP. The response frame request component 1240 may be configured to support aspects described above in connection with at least FIGS. 3A and 3B.

The uplink transmission schedule component 1245 may be configured to repeat a schedule provided by a Primary AP so that a Secondary AP may receive the information contained in the schedule. The uplink transmission schedule component 1245 may be configured to support aspects described above in connection with at least FIG. 8 that are related to a wireless station.

In one aspect of the operation of the uplink transmission and response frame controller 1210, the wireless station 1215 may transmit, via the transceiver 1295, uplink data to a primary access point and a secondary access point, the wireless station 1215 transmitting the uplink data from within an overlapping coverage area of the primary access point and the secondary access point (see e.g., FIG. 1A). The uplink data may be provided by, for example, the uplink data transmission component 1220. The wireless station 1215 may then receive, via the transceiver 1295, an indication from the secondary access point that the uplink data has been forwarded by the secondary access point to the primary access point. In some examples, the uplink data forwarded by the secondary access point to the primary access point may include demodulated payload bits and decoded information associated with the uplink data. The wireless station 1215 may then transmit a request to the primary access point for a block response frame associated with the uplink data in response to receiving the indication from the secondary access point. In this regard, the response frame request component 1240 may generate the request after receiving the indication and may send the request to the primary access point in connection with the transceiver 1295.

FIG. 13 shows a flow chart illustrating an example of aspects of a method 1300 for setting up or configuring cooperative reception. At 1310, a first access point (e.g., Primary AP such as AP1 105-a in FIGS. 1-2B and AP 1005 in FIG. 10) may determine that a quality metric (e.g., RSSI, UL throughput) associated with a wireless station (e.g., STA1 115-a in FIGS. 1-2B, STA 1215 in FIG. 12) is less than a predetermined threshold. For example, the cooperative reception setup component 1030 and/or the quality metric comparison component 1035 in FIG. 10 may determine whether a quality metric exceeds a predetermined threshold.

At 1315, the first access point (may configure or implement cooperative reception when in response to a determination being made at 1310 that the quality metric associated with the wireless station is less than the predetermined threshold.

At 1320, a second access point (e.g., Secondary AP such as AP2 105-b in FIGS. 1-2B and AP 1105 in FIG. 11) may be identified for cooperative reception. For example, the cooperative reception setup component 1030 and/or the identification component 1040 in FIG. 10 may identify one or more second access points (e.g., Secondary APs).

At 1325, cooperative reception may be configured between the first access point and the second access point in which the second access point forwards uplink data (e.g., decoded MPDUs) to the first access point. For example, the cooperative reception setup component 1030, the configuration component 1045, and/or the inter-AP communications link component 1050 in FIG. 10 may set up, configure, or establish the cooperative reception between the first access point (Primary AP) and the second access point (Secondary AP).

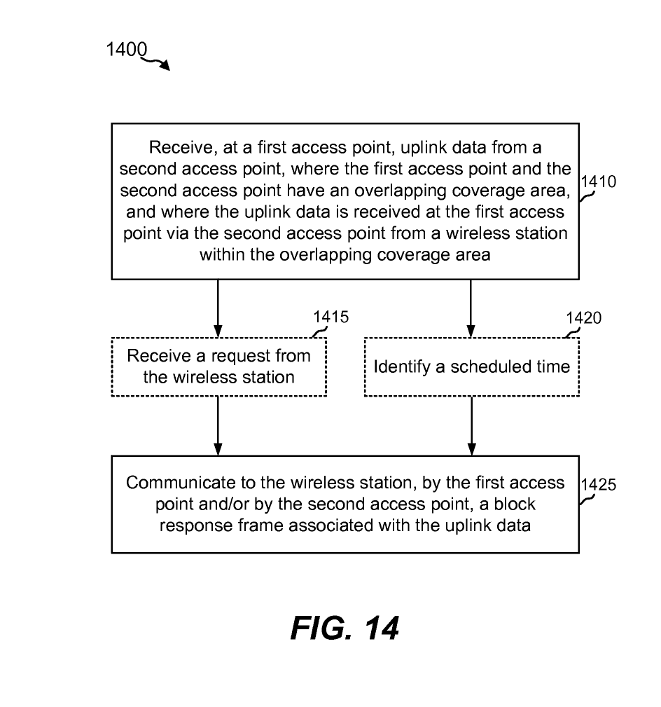

FIG. 14 shows a flow chart illustrating an example of aspects of a method 1400 for cooperative reception. At 1410, uplink data (e.g., decoded MPDUs) may be received at a first access point (e.g., Primary AP such as AP1 105-a in FIGS. 1-2B and AP 1005 in FIG. 10) from a second access point (e.g., Secondary AP such as AP2 105-b in FIGS. 1-2B and AP 1105 in FIG. 11), where the first access point and the second access point have an overlapping coverage area (see e.g., overlap between coverage areas 110-a and 110-b in FIG. 1), and where the uplink data is received at the first access point via the second access point from a wireless station (e.g., STA1 115-a in FIG. 1) within the overlapping coverage area. For example, the data processor 1020 and/or the transceiver 1095 in FIG. 10 may receive uplink data (e.g., uplink data 1025).

Optionally at 1415, a request (e.g., request 320 in FIGS. 3A and 3B) may be received from the wireless station. For example, the response frame controller 1055 and/or the request reception component 1080 may receive a request from a wireless station to provide the wireless station with the cooperative reception results.

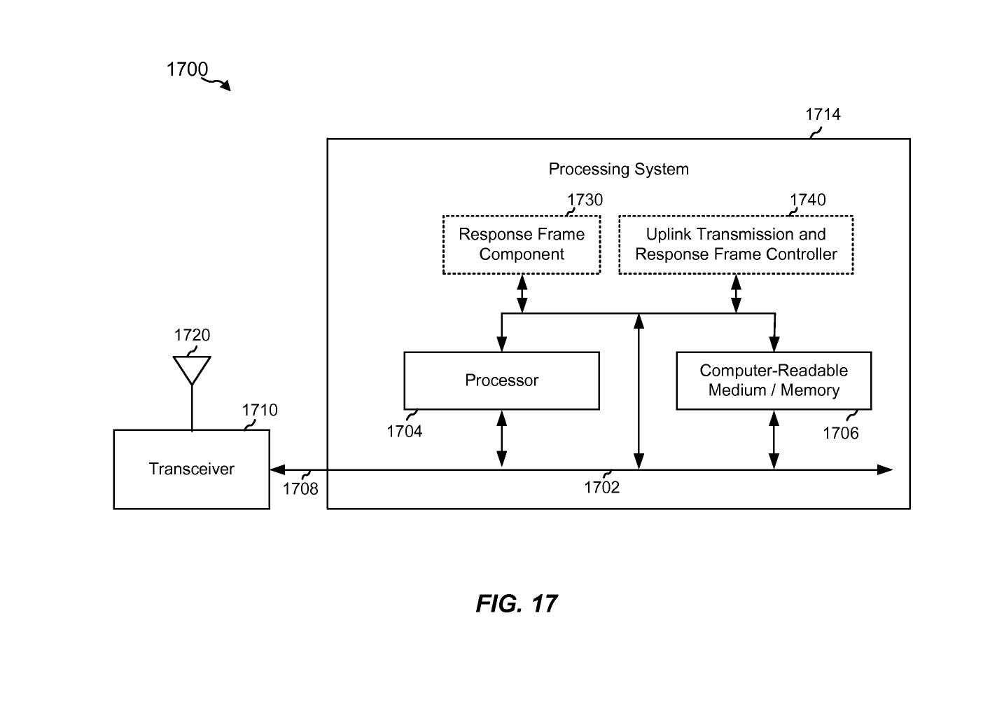

Alternatively and optionally at 1420, a scheduled time (e.g., Tscheduled in FIG. 4A) may be identified at the first access point. For example, the response frame controller 1055 and/or the communication time identifying component 1065 may identify a scheduled time for the transmission of a block response frame to the wireless station. The scheduled time may be stored in memory (see e.g., computer-readable medium/memory 1706 in FIG. 17) as part of a configuration of the first access point.

At 1425, the first access point may communicate a block response frame (e.g., BRF 325 in FIGS. 3A and 3B, and BRF 425 in FIG. 4A) associated with the uplink data. For example, the response frame controller 1055, the block response frame communication component 1085, and/or the transceiver 1095 may communicate a block response frame to the wireless station. The block response frame may include a BA frame.

In another aspect of the method 1400, receiving the request at 1415 includes receiving the request from the wireless station sent in response to the wireless station receiving an indication from the second access point that the uplink data has been forwarded by the second access point to the first access point.

In another aspect of the method 1400, the scheduled time at 1420 may be a time within a scheduled time window configured at the access point.

In another aspect of the method 1400, a first scheduled time may be identified at the first access point, where communicating to the wireless station a block response frame occurs at the first scheduled time, and where the first scheduled time is based on a time at which the uplink data (e.g., UL AMPDU) is received by the first access point directly from the wireless station (see e.g., FIG. 7). The second access point may communicate to the wireless station a separate block response frame at a second scheduled time, and where the second scheduled time is offset (e.g., time offset) from the first scheduled time. In some examples, the first scheduled time at which the first access point communicates to the wireless station the block response frame (e.g., BRF1 725-a in FIG. 7) occurs before the second scheduled time at which the second access point communicates to the wireless station the separate or second block response frame (e.g., BRF2 725-b in FIG. 7).

In another aspect of the method 1400, a schedule (e.g., schedule 815 in FIG. 8) may be communicated to the wireless station (e.g., STA-a in FIG. 8) and to a second wireless station (e.g., STA-b in FIG. 8), where the wireless station communicates, for example, uplink aggregate data corresponding to the uplink data based on the schedule, and where the wireless station and the second wireless station repeat the schedule (e.g., schedule 820-a and schedule 820-b in FIG. 8) to the second access point.

In another aspect of the method 1400, for STA-driven cooperative reception setup, in response to an indication from the wireless station, cooperative reception may be configured between the first access point and the second access point in which the second access point forwards the uplink data to the first access point.

In another aspect of the method 1400, for AP-driven cooperative reception setup, it may first be determined to configure cooperative reception when a quality metric (e.g., RSSI, UL throughput) associated with the wireless station is less than a predetermined threshold. One or more second access points (e.g., Secondary APs) may be identified for cooperative reception. Cooperative reception may then be configured at the first access point between the first access point and the second access point in which the second access point forwards the uplink data to the first access point.

In another aspect of the method 1400, the first access point may receive the uplink data from the second access point through a communications link (e.g., inter-AP communications link 230 in FIG. 2B) between the first access point and the second access point.

In the method 1400 described above, the Secondary AP (e.g., second access point) may forward decoded MPDUs to the Primary AP (e.g., first access point). Another approach may be to have the Secondary AP(s) forward demodulated raw bits (not decoded) for each MPDU to the Primary AP. In such a case, the Primary AP may make a final decoding decision based on the demodulated raw bits from the Secondary AP(s). The Primary AP may then send a block response frame (e.g., BA frame) to the STA either directly at a scheduled time/scheduled time window as described above for FIGS. 4A and 4B, or indirectly through a request (e.g., BAR) from the STA as described above for FIGS. 3A and 3B.

In an example of forwarding undecoded bits, the STA may first encode MPDU information separately from the payload for each MPDU in an UL data frame. The MPDU information may include transmitter ID, receiver ID, and sequence number for each MPDU. This information can be encoded in a PHY header or a MAC header, separate from the payload contents of the MPDU.

After receiving each MPDU in the UL data frame, the Secondary AP may decode the MPDU information and may forward the decoded MPDU information to the Primary AP. The Secondary AP may also forward demodulated but undecoded MPDU payload bits to the Primary AP. The Primary AP may identify the demodulated payload bits from the same MPDU from different Secondary APs based on the decoded MPDU information. Then, for each demodulated payload bit, the Primary AP may select as the bit value the value agreed upon by a majority of the Secondary APs. For example, if more than half of the Secondary APs provide a value of “1” for a particular payload bit and the remaining Secondary APs provide a value of “0” for that payload bit, the Primary AP may determine the value of that payload bit to be “1”. The Primary AP may do the same for all of the demodulated payload bits and may provide the processed demodulated bit sequence to a decoder in the Primary AP for final decoding (e.g., to produce a decoded bit sequence).

FIG. 15 shows a flow chart illustrating an example of aspects of a method 1500 for cooperative reception in which demodulate but undecoded MPDU payload bits are forwarded instead of decoded MPDU bits. At 1510, a first access point (e.g., Primary AP such as AP1 105-a in FIGS. 1-2B and AP 1005 in FIG. 10) may receive demodulated payload bits (e.g., MPDU payload bits) and decoded information (e.g., MPDU information) from one or more second access points (e.g., Secondary AP such as AP2 105-b in FIGS. 1-2B an AP 1105 in FIG. 11), where the first access point and the one or more second access points have an overlapping coverage area (see e.g., overlap between coverage areas 110-a and 110-b in FIG. 1), and where the demodulated payload bits and the decoded information are forwarded to the first access point by the one or more second access points after being obtained by the one or more second access points from uplink data transmitted by a wireless station (e.g., STA1 115-a in FIG. 1) within the overlapping coverage area. For example, the data processor 1020 and/or the transceiver 1095 in FIG. 10 may receive demodulated payload bits and decoded information (e.g., demodulated bits/decoded information 1027).

At 1515, at least a demodulated bit sequence may be determined from the demodulated payload bits from the one or more secondary access points. For example, the data processor 1020 may determine the demodulated bit sequence.

At 1520, the at least a demodulated bit sequence may be decoded to produce a decoded bit sequence. The decoding may be based on combining the at least a demodulated bit sequence. In one example, the data processor 1020 may produce the decoded bit sequence.

At 1525, a block response frame (e.g., BRF 325 in FIGS. 3A and 3B, and BRF 425 in FIG. 4A) associated with the decoded bit sequence may be communicated to the wireless station. For example, the response frame controller 1055, the block response frame communication component 1085, and/or the transceiver 1095 may communicate a block response frame to the wireless station. The block response frame may include a BA frame.

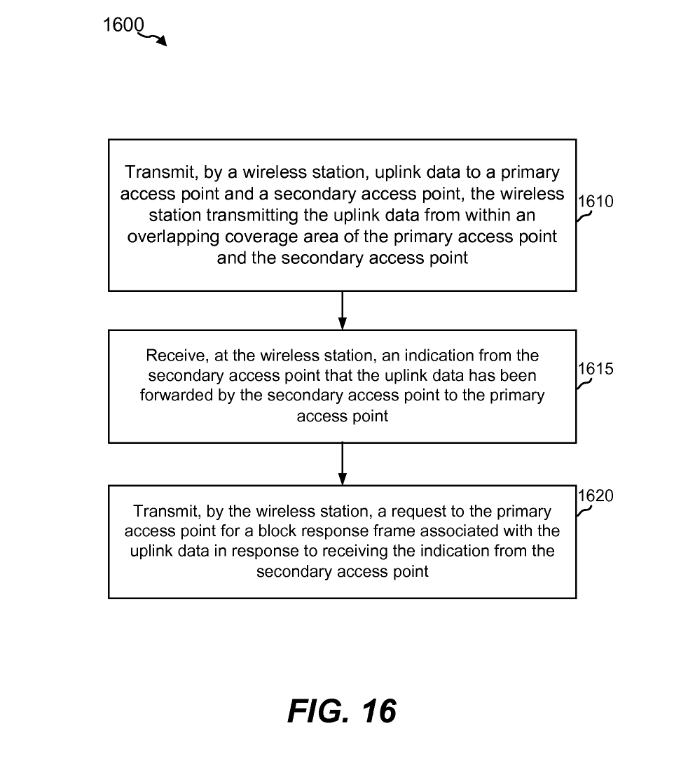

FIG. 16 shows a flow chart illustrating an example of aspects of a method 1600 for operations of a wireless station in cooperative reception. At 1610, a wireless station (e.g., STA1 115-a in FIGS. 1-2B, STA 1215 in FIG. 12) may transmit uplink data to a primary access point (e.g., AP1 105-a in FIGS. 1-2B and AP 1005 in FIG. 10) and a secondary access point (e.g., AP2 105-b in FIGS. 1-2B and AP 1105 in FIG. 11), the wireless station transmitting the uplink data from within an overlapping coverage area of the primary access point and the secondary access point.

At 1615, the wireless station may receive an indication (e.g., a frame such as a forwarding finish 345 in FIG. 3B) from the secondary access point that the uplink data has been forwarded by the secondary access point to the primary access point.

At 1620, the wireless station may transmit a request (e.g., request 320 in FIG. 3B) to the primary access point for a block response frame (e.g., BRF 325 in FIG. 3B) associated with the uplink data in response to receiving the indication from the secondary access point.

In another aspect of the method 1600, transmitting the uplink data may include transmitting a first frame (e.g., start 335 in FIG. 3B) indicating a start of the uplink data and a second frame (e.g., end 340 in FIG. 3B)

FIG. 17 shows a block diagram 1700 illustrating an example of a processing system 1714 configured for performing various techniques described in this disclosure for response frames in cooperative reception. The processing system 1714 may be implemented with a bus architecture, represented generally by the bus 1702. The bus 1702 may include any number of interconnecting buses and bridges depending on the specific application of the processing system 1714 and the overall design constraints. The bus 1702 links together various circuits including one or more processors and/or hardware modules, represented by a processor 1704 and a computer-readable medium/memory 1706. The bus 1702 may also link various other circuits such as timing sources, peripherals, voltage regulators, and power management circuits, which are well known in the art, and therefore, will not be described any further. The processing system 1714 may also include a response frame component 1730 when part of an access point (e.g., access point 1005 in FIG. 10 or access point 1105 in FIG. 11) or an uplink transmission and response frame controller 1740 when part of as a wireless station (e.g., wireless station 1215 in FIG. 12).

The processing system 1714 may be coupled to a transceiver 1710 via an interface 1708. The transceiver 1710 is coupled to one or more antennas 1720. The transceiver 1710 may provide a means for communicating with various other apparatus or devices over a transmission medium. The transceiver 1710 may receive a signal from the one or more antennas 1720, may extract information from the received signal, and may provide the extracted information to the processing system 1714, specifically the processor 1704, the uplink transmission and response frame controller 1740, and/or the response frame component 1730. In addition, the transceiver 1710 may receive information from the processing system 1714, specifically the processor 1704, the uplink transmission and response frame controller 1740, and/or the response frame component 1730, and based on the received information, may generate a signal to be applied to the one or more antennas 1720. The processing system 1714 includes the processor 1704 coupled to the computer-readable medium/memory 1706, and/or to the response frame component 1630, which may be an example of the Primary AP response frame component 1010 (FIG. 10) or the Secondary AP response frame component 1110 (FIG. 11). In some instances, when an AP performs the functions of both a Primary AP and a Secondary AP, the response frame component 1630 may include the components of both the Primary AP response frame component 1010 and the Secondary AP response frame component 1110, or may perform the functions of both the Primary AP response frame component 1010 and the Secondary AP response frame component 1110. The processor 1704 is responsible for general processing, including the execution of software stored on the computer-readable medium/memory 1706. The software, when executed by the processor 1704, causes the processing system 1714 to perform the various functions described in the disclosure for response frames in cooperative reception. The computer-readable medium/memory 1706 may also be used for storing data that is manipulated by the processor 1704 when executing software. The response frame component 1730 may be software module running in the processor 1704, resident/stored in the computer readable medium/memory 1706, a hardware module coupled to the processor 1704, or some combination thereof. In some instances, the processor 1704 and the computer readable medium/memory 1706 may be used to perform functions, operations, or features described herein with respect to one or more of the components of a response frame component (e.g., components of the Primary AP response frame component 1010 and/or the Secondary AP response frame component 1110).

As described above, the processing system 1714 may include the uplink transmission and response controller 1740 instead of the response frame component 1730 when part of a wireless station. In such cases, the uplink transmission and response controller 1740 may operate in connection with the processor 1704 and/or the computer-readable medium/memory 1706 in a manner similar as that described above for the response frame component 1730. The uplink transmission and response controller 1740 may be an example of the uplink transmission and response controller 1210 in FIG. 10. In some instances, however, a device may operate as both an AP and a wireless station and may include both the response frame component 1730 and the uplink transmission and response frame controller 1740.

The apparatus and methods have been described in the detailed description and illustrated in the accompanying drawings by various elements comprising blocks, modules, components, circuits, steps, processes, algorithms, and the like. These elements, or any portion thereof, either alone or in combinations with other elements and/or functions, may be implemented using electronic hardware, computer software, or any combination thereof. Whether such elements are implemented as hardware or software depends upon the particular application and design constraints imposed on the overall system. In an aspect, the term “component” as used herein may be one of the parts that make up a system and may be divided into other components.

By way of example, an element, or any portion of an element, or any combination of elements may be implemented with a “processing system” that includes one or more processors. A processor may include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on transitory or non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections within a processing system may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses.

The various aspects of this disclosure are provided to enable one of ordinary skill in the art to practice the present invention. Various modifications to examples of implementations presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the examples of implementations described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112 (f) or 35 U.S.C. §112, sixth paragraph, whichever is appropriate, unless the element is expressly recited using the phrase “means for” or, in the case of a method claim, the element is recited using the phrase “step for.”

What is claimed is:

1. A method for cooperative reception, comprising:
receiving, at a first access point, uplink data from a second access point, wherein the first access point and the second access point have an overlapping coverage area, and wherein the uplink data is received at the first access point via the second access point from a wireless station within the overlapping coverage area; and
communicating to the wireless station, by the first access point, a block response frame associated with the uplink data.

2. The method of claim 1, further comprising receiving a request from the wireless station at the first access point, wherein communicating to the wireless station the block response frame occurs in response to receiving the request.

3. The method of claim 2, wherein receiving the request comprises receiving the request from the wireless station sent in response to the wireless station receiving an indication from the second access point that the uplink data has been forwarded by the second access point to the first access point.

4. The method of claim 1, further comprising identifying, by the first access point, a scheduled time, wherein communicating to the wireless station the block response frame occurs at the scheduled time.

5. The method of claim 4, wherein the scheduled time is a time within a scheduled time window configured at the first access point.

6. The method of claim 4, further comprising contending, at the scheduled time, for a communications channel to communicate the block response frame to the wireless station.

7. The method of claim 1, further comprising identifying, by the first access point, a first scheduled time, wherein communicating to the wireless station the block response frame occurs at the first scheduled time, and wherein the first scheduled time is based on a time at which the uplink data is received by the first access point directly from the wireless station.

8. The method of claim 7, wherein the first scheduled time at which the first access point communicates the block response frame occurs before a second scheduled time at which the second access point communicates to the wireless station a separate block response frame.

9. The method of claim 7, wherein the first scheduled time at which the first access point communicates the block response frame is offset from a trigger frame sent by the wireless station to the second access point for the second access point to send a separate block response frame associated with the uplink data.

10. The method of claim 7, wherein the block response frame communicated by the first access point indicates that a portion of MAC service data units (MSDUs) in the uplink data received by the first access point directly from the wireless station that fail decoding is greater than a predetermined threshold.

11. The method of claim 7, wherein receiving the uplink data from the second access point comprises receiving the uplink data via the second access point from the wireless station after communicating the block response frame to the wireless station at the first scheduled time.

12. The method of claim 1, further comprising configuring at the first access point, in response to an indication from the wireless station, cooperative reception between the first access point and the second access point in which the second access point forwards the uplink data to the first access point.

13. The method of claim 1, wherein the block response frame comprises a block acknowledgement (BA) frame that includes acknowledgment information associated with reception pass or failure results for at least one MSDU or fragmented MSDU in the uplink data.

14. The method of claim 1, wherein the first access point receives the uplink data from the second access point through a communications link between the first access point and the second access point.

15. The method of claim 1, further comprising:
identifying at least a demodulated bit sequence from demodulated payload bits and decoded information in the uplink data from one or more second access points including the second access point; and
decoding the demodulated bit sequence to produce a decoded bit sequence, and
wherein communicating to the wireless station comprises communicating a block response frame associated with the decoded bit sequence, the block response frame having a BA frame that includes acknowledgment information associated with reception pass or failure results for at least one MSDU or fragmented MSDU in the uplink data.

16. An apparatus for cooperative reception, comprising:
means for receiving, at a first access point, uplink data from a second access point, wherein the first access point and the second access point have an overlapping coverage area, and wherein the uplink data is received at the first access point via the second access point from a wireless station within the overlapping coverage area; and
means for communicating to the wireless station a block response frame associated with the uplink data.

17. The apparatus of claim 16, further comprising means for receiving a request from the wireless station at the first access point, wherein the means for communicating is further configured for communicating to the wireless station the block response frame in response to the receiving request.

18. The apparatus of claim 17, wherein the means for receiving is further configured for receiving the request from the wireless station sent in response to the wireless station receiving an indication from the second access point that the uplink data has been forwarded by the second access point to the first access point.

19. The apparatus of claim 16, further comprising means for identifying, by a first access point, a scheduled time, wherein the means for communicating is further configured for communicating to the wireless station the block response frame at the scheduled time.

20. The apparatus of claim 16, further comprising means for identifying, by a first access point, a first scheduled time, wherein the means for communicating is further configured for communicating to the wireless station the block response frame at the first scheduled time, and wherein the first scheduled time is based on a time at which the uplink data is received by the first access point directly from the wireless station.

21. The apparatus of claim 20, wherein the first scheduled time at which the first access point communicates to the wireless station the block response frame occurs before a second scheduled time at which the second access point communicates to the wireless station a separate block response frame associated with the uplink data.

22. The apparatus of claim 16, wherein the block response frame comprises a block acknowledgement (BA) frame that includes acknowledgment information associated with reception pass or failure results for at least one MSDU or fragmented MSDU in the uplink data.

23. An apparatus for cooperative reception, comprising:
a processor; and
a memory coupled with the processor, the memory storing instructions, that when executed by the processor, cause the processor to:
receive, at a first access point, uplink data from a second access point, wherein the first access point and the second access point have an overlapping coverage area, and wherein the uplink data is received at the first access point via the second access point from a wireless station within the overlapping coverage area; and
communicate to the wireless station a block response frame associated with the uplink data.

24. The apparatus of claim 23, wherein the instructions, when executed by the processor, cause the processor to receive, at the first access point, a request from the wireless station, and to communicate to the wireless station the block response frame in response to the receiving the request.

25. The apparatus of claim 24, wherein the instructions, when executed by the processor, cause the processor to receive the request from the wireless station sent in response to the wireless station receiving an indication from the second access point that the uplink data has been forwarded by the second access point to the first access point.

26. The apparatus of claim 23, wherein the instructions, when executed by the processor, cause the processor to identify, at the first access point, a scheduled time, and to communicate to the wireless station the block response frame at the scheduled time.

27. The apparatus of claim 24, wherein the instructions, when executed by the processor, cause the processor to identify, at the first access point, a first scheduled time, and to communicate to the wireless station the block response frame at the first scheduled time, and wherein the first scheduled time is based on a time at which the uplink data is received by the first access point directly from the wireless station.

28. The apparatus of claim 27, wherein the first scheduled time at which the first access point communicates to the wireless station the block response frame occurs before a second scheduled time at which the second access point communicates to the wireless station a separate block response frame associated with the uplink data.

29. The apparatus of claim 23, wherein the block response frame comprises a block acknowledgement (BA) frame that includes acknowledgment information associated with reception pass or failure results for at least one MSDU or fragmented MSDU in the uplink data.

30. An apparatus for cooperative reception, comprising:
a processor; and
a memory coupled with the processor, the memory storing instructions, that when executed by the processor, cause the processor to:
transmit, by a wireless station, uplink data to a primary access point and a secondary access point, the wireless station transmitting the uplink data from within an overlapping coverage area of the primary access point and the secondary access point;
receive, at the wireless station, an indication from the secondary access point that the uplink data has been forwarded by the secondary access point to the primary access point; and
transmit, by the wireless station, a request to the primary access point for a block response frame associated with the uplink data in response to receiving the indication from the secondary access point.
